(19) United States
(12) Patent Application Publication
(10) Pub. No.: US 2016/0083830 A1
(43) Pub. Date: Mar. 24, 2016

(54) READABLE THERMAL SPRAY

(71) Applicant: Scoperta, Inc., San Diego, CA (US)

(72) Inventors: Justin Lee Cheney, Encinitas, CA (US); Kyle Walter Rafa, Fremont, CA (US)

(21) Appl. No.: 14/858,852

(22) Filed: Sep. 18, 2015

Related U.S. Application Data
(60) Provisional application No. 62/052,671, filed on Sep. 19, 2014.

(51) Int. Cl. C23C 4/08; C22C 38/56; C22C 38/54; C22C 38/50; B32B 15/01; C22C 38/46; C22C 38/44; C22C 38/06; C23C 4/12; C23C 4/06; C22C 38/58; C22C 38/48

(52) U.S. Cl. CPC C23C 4/08; C22C 38/58; C22C 38/56; C22C 38/54; C22C 38/50; C22C 38/48; C22C 38/46; C22C 38/44; C22C 38/06; C23C 4/125; C23C 4/06; B32B 15/01; B32B 15/011

(57) ABSTRACT

Embodiments of an iron-based coating configured to be thermally sprayed are disclosed. The iron-based coatings can be generally non-magnetic, thus allowing for thickness measurements to be performed on the coating with standard magnetic measuring equipment. Further, the iron-based coating can have advantageous properties, such as high hardness, high wear resistance, and high adhesion strength.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

This disclosure generally relates to low magnetism iron-based alloys able to be thermally sprayed onto a substrate for use in corrosion and erosion environments while maintaining the ability to monitor the coating thickness using magnetic thickness gages.

2. Description of the Related Art

There are many techniques utilized in thermal spraying a coating including twin wire arc spray (TWAS), high velocity oxygen spray (HVOF), plasma spray, combustion spray and detonation gun spray. While all of the methods are similar, however TWAS is considered the simplest.

Alloy wires, either solid, metal, or flux cored, are used as the feedstock for the twin wire arc spray process. As the spray wire is fed into the gun, it is melted into small particles. For example, two wires are simultaneously fed through the spray gun each applied with opposite voltage. The voltage gap arcs the two wires at a connection point in the gun, melting the wire at the tip. A gas stream is then applied behind the melt interface to atomize and spray the resultant liquid metal droplets onto a substrate to form a coating. Specifically, the particles are accelerated towards the substrate and impact in a semi-molten state. Upon impact, the particles flatten on top of the substrate or previously flattened particles, forming a mechanical bond. These layers of flattened particles also consist of small amounts of porosity and oxides between particles. The particle velocity can reach up to 100 m/s in TWAS and 600 m/s in Plasma and HVOF. The typical particle temperatures are between 1800-3500° C., though thermal spray has lower heat input compared to weld overlay because if the heat input is high, the substrate can experience embrittlement or dimensional warping.

Thermal spray coatings provide many benefits to harsh corrosion environments. For example, they can allow using boilers and tubes manufactured from inexpensive materials for the bulk of the part, while coating with a specialized corrosion resistant material capable of extended service life. Over time, the coating slowly corrodes and rather than replace the entire boiler, a new layer of coating can be applied potentially extending the life of the boiler indefinitely.

The industry demand still remains for a “readable” thermal spray, which is typically executed with a paint gauge thickness measurement device such as an Elcometer 456 or similar. However, not all coating alloys are suitable for this technique. For example, few, if any, iron based thermal spray coatings are able to be measured using magnetic thickness gages as these conventional iron based coatings are magnetic. Thus, nickel-based coatings, which are typically non-magnetic, are used as they can be read with this technique. However, nickel-based materials are significantly more expensive than Fe-based materials. Therefore, due to the relative low cost and potential performance benefits of iron based alloys in comparison with nickel based alloys, there is a need for Fe-based readable alloys.

Further, currently used coatings which are able to be magnetically measured utilize an amorphous microstructure. In amorphous materials, the crystalline structure in normal metal alloys is prevented from forming by both alloying elements and cooling rate. A large amount of alloying elements of varying atomic sizes can cause random bonding within the metal and can prevent the formation of crystalline grains. If the cooling rate is sufficiently high, then a crystalline structure is also prevented from forming.

Additionally, in the alloys currently used for sprayed coatings, they remain “readable” at low temperatures below 600° C. If the operable temperature is above this, then devitrification occurs where the amorphous structure transforms into a nano-crystalline structure and loses is readability.

### SUMMARY

In some embodiments, the present disclosure relates to an alloy able to be thermally sprayed onto a substrate in a nano-crystalline form while maintaining low magnetic permeability allowing for measurement using a magnetic thickness gage. The thermal spray coating alloy can contain as a composition in wt. %: Mn: 10-18, Cr: 3-6, Nb: 3-6, V: 0-5, C: 2-5, W: 3-6, Ni: 0-3, Al: 0-3 Ti: 0-0.5, balance Fe and manufacturing impurities. The coating in the as-sprayed condition has a wear loss of 1.4 g as measured according to ASTM G65 procedure A. The coating can be comprised of many austenitic or semi-austenitic splats mechanically bonded together. The measured precision using an Elcometer magnetic thickness gage is ±0.001″.

Disclosed herein are embodiments of a Fe-based thermal spray coating formed from an alloy, the coating comprising a high abrasion resistance as characterized by ASTM G65B mass loss of 1.4 grams or less and a generally austenitic matrix having at least 60 wt. % Fe, wherein the coating is non-magnetic and is readable with a magnetic thickness gauge.

In some embodiments, a composition of the coating or the alloy can comprise, in wt. %, Fe, B+C: about 1 to about 6, Mn+Ni: about 8 to about 16, and Al+Si: about 0 to about 14. In some embodiments, a composition of the coating or the alloy can comprise, in wt % Fe, Mn: about 10 to about 18, Cr: about 3 to about 6, Nb: about 3 to about 6, V: about 0 to about 6, C: about 2 to about 5, W: about 3 to about 6, Ni: about 0 to about 3, Al: about 0 to about 3, and Ti: about 0 to about 0.5.

In some embodiments, the coating can have a wear loss of 0.6 g as measured according to ASTM G65 procedure B. In some embodiments, the coating can have an adhesion strength of 5,000 psi or higher. In some embodiments, the coating can exhibit less than 200 mg loss in hot erosion testing at 600° C. and a 30° impingement angle. In some embodiments, a thickness of the coating can be read by the magnetic thickness gauge within 20% of a 0-1 micrometer measurement. In some embodiments, a thickness of the coating can be measured within 25% standard deviation in measurement by a magnetic thickness gauge. In some embodiments, the alloy can be a powder.

Also disclosed herein are embodiments of a component in power generation equipment at least partially coated by the thermal spray coating disclosed herein.

Also disclosed herein are embodiments of a thermal spray coating formed from an alloy, the coating comprising an iron based matrix. at least 5 wt. % elemental solute within the matrix, and a high abrasion resistance as characterized by ASTM G65B mass loss of 1.4 grams or less, wherein the coating is non-magnetic and is readable with a magnetic thickness gauge, and wherein the alloy has a thermodynamic stable transition from austenite to ferrite at 950 K or below.

In some embodiments, a composition of the coating or the alloy can comprise, in wt. %, Fe, B+C: about 1 to about 6, Mn+Ni: about 8 to about 16, and Al+Si: about 0 to about 14.

In some embodiments, a composition of the coating or the alloy can comprise, in wt. %, Fe, Mn: about 10 to about 18, Cr: about 3 to about 6, Nb: about 3 to about 6, V: about 0 to about 6, C: about 2 to about 5, W: about 3 to about 6, Ni: about 0 to about 3, Al: about 0 to about 3, and Ti: about 0 to about 0.5.

In some embodiments, the matrix can comprise at least 10 wt. % elemental solute. In some embodiments, the matrix can comprise at least 15 wt. % elemental solute. In some embodiments, the alloy can exhibit a thermodynamic stable transition from austenite to ferrite at 900 K or below. In some embodiments, the matrix can have over 90% austenite by volume and at least one non-magnetic oxide inclusion. In some embodiments, the coating can have a microhardness of 400 Vickers or higher. Further disclosed herein are embodiments of a component in power generation equipment at least partially coated by the thermal spray coating disclosed herein

Also disclosed herein are embodiments of a method for thermally applying a coating to a substrate, the method comprising thermally spraying an iron-based powder alloy onto the substrate to form a coating, wherein the coating is non-magnetic and is readable with a magnetic-thickness gauge, wherein the coating has a microhardness of 400 Vickers or higher, and wherein the coating has high abrasion resistance as characterized by ASTM G65B mass loss of 1.4 grams or less.

### BRIEF DESCRIPTION OF THE DRAWINGS

FIG. 1 is an illustration of the stresses experienced by a thermal spray coating and how they cause delamination.

FIG. 2 shows a thermodynamic solidification model for Alloy X3.

FIG. 3 shows the microstructure for Alloy X3 as a scanning electron micrograph.

FIG. 4 is an optical micrograph for X3 at 200× magnification.

### DETAILED DESCRIPTION

The alloys disclosed herein can be used for the formation of coatings, particular those having advantageous physical properties while remaining readable to magnetic sensors. In some embodiments, the alloys can be iron-based alloys used in thermal spray coatings while still remaining magnetically readable.

In order to be readable, embodiments of the alloys listed in the present disclosure can be austenitic (FCC gamma-phase iron) and thus they are non-magnetic and do not interfere with magnetic thickness measurements. This allows quick measurement of many different locations during initial spraying without destructive testing to insure the correct thickness of coating is applied. It also allows for monitoring of the thickness during use to determine the remaining life of the coating.

Additionally, embodiments of the disclosed alloys can be used at high operation temperatures, which can be defined as the temperature in which the alloys remain austenitic as a coating (e.g., the melting temperature of the material). In some embodiments, the operating range for embodiments of the alloys can be from 0 to 1300° (or about 0 to about) 1300°, or generally between 0 and 0.95*melting temperature of the alloy (or between about 0 and about 0.95*melting temperature of the alloy).

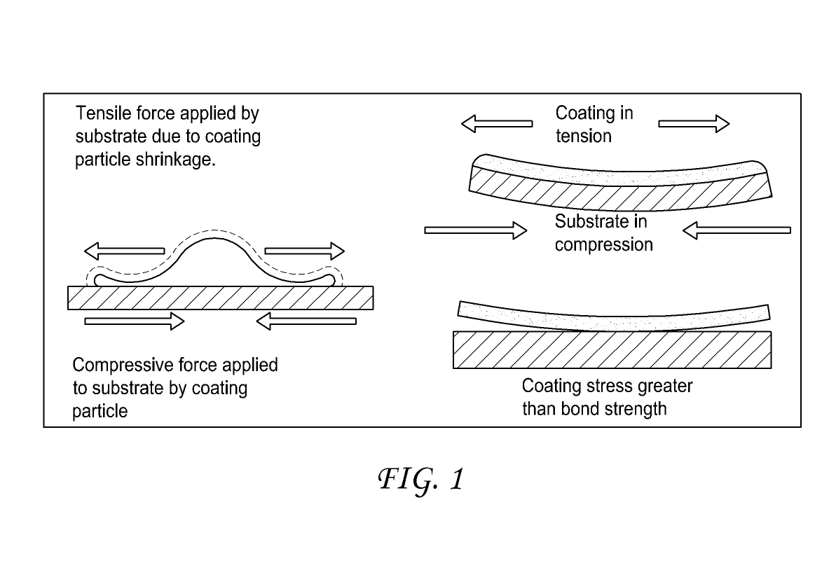

Further, embodiments of the disclosed alloys can have high adhesion. With low adhesion, the coating can delaminate when exposed to large temperature changes due to thermal expansion mismatch with the substrate (see FIG. 1). Also higher adhesion values allow for thicker coatings to be deposited which allows for longer service life with fewer replacements or repairs of the coatings. After a thermal spray coating is deposited, it remains in a state of tension. As coatings get thicker, this tension force increases and can exceed the adhesion strength of the coating, “peeling” away from the substrate.

Thermal sprays such as those disclosed herein can be used for many applications, but one specific application of interest for the present disclosure is industrial boilers, such as those used in coal power plants. These boilers are subject to extreme heat for extended periods of time. At the same time, there is ash and other combustion by-products released by the heating process which deposit on the boiler tubes and walls. Embodiments of the disclosed alloys can be advantageously used on industrial boilers.

The following terms will be used throughout the specification and will have the following meanings unless otherwise indicated.

Splat refers to the individual metal particle comprising the coating. The semi-molten metal sprayed from the thermal spray gun impacts the substrate or previously deposited particles, flattening and forming a mechanical bond.

Coating is the as-sprayed form of a metal onto a substrate for corrosion and/or erosion resistance. It is comprised of many splats layered together to form a layer with minimal porosity.

Adhesion refers to the mechanical bond between the thermal spray coating and the substrate.

Feedstock chemistry refers to the chemistry of the wire before it has been submitted to the twin wire arc spray process (or other thermal spray process).

Final coating chemistry refers to the chemistry of the coating after the wire has been melted and sprayed onto the substrate.

As disclosed herein, the term alloy can refer to the chemical composition forming the powder disclosed within, the powder itself, and the composition of the metal component formed by the heating and/or deposition of the powder.

### Alloy Composition

In some embodiments, alloys can be described by particular alloy compositions. Embodiments of chemistries of alloys within this disclosure are shown in Table 1.

TABLE 1
Alloys manufactured into cored wire for thermal spray trials

| Al- | | | | | | | | | | | |
|---|---|---|---|---|---|---|---|---|---|---|---|
| loy | Mn | Cr | Nb | V | C | B | W | Si | Ti | Ni | Al |
| X1 | 12 | 5 | 4 | 0.5 | 4 | 0 | 5 | 0 | 0.2 | 1 | 0 |
| X2 | 11.88 | 4.95 | 3.96 | 0.495 | 3.96 | 0 | 4.95 | 0 | 0.198 | 2 | 0 |
| X3 | 12 | 5 | 4 | 0.5 | 4 | 0 | 5 | 0 | 0.2 | 2 | 1 |
| X4 | 12 | 5 | 4 | 0.5 | 4 | 0 | 5 | 0 | 0.2 | 0 | 2 |

In some embodiments, the alloys can be described by compositional ranges which meet the below disclosed thermodynamic criteria. In some embodiments, the alloy can comprise:

Al: 0-10 (or about 0 to about 10)

B: 0-3 (or about 0 to about 3)

C: 0-6 (or about 0 to about 6)

Mn: 0-16 (or about 0 to about 16)

Ni: 0-16 (or about 0 to about 16)

Si: 0-10 (or about 0 to about 10)

In some embodiments, the alloy may further comprise:

B+C: 1-6 (or about 1 to about 6)

Mn+Ni: 8-16 (or about 8 to about 16)

Al+Si: 0-14 (or about 0 to about 14)

In some embodiments, 0 wt. % Ni (or about 0 wt. % Ni) can be used in the alloy compositions. In some embodiments, 1-2 wt. % nickel can be used. In some embodiments, Mn can be exchanged out for Ni.

In some embodiments, the alloys can have a particular compositional ratio. For example, the alloy can have (Mn+Ni)/(Al+Si)=0.8 to 8 (or about 0.8 to about 8). This is the ratio of “austenite formers” to “ferrite stabilizing de-oxidizers,” as discussed in detail below. However, it will be understood that Al and Si is not in every alloy. For example, if high amounts of Mn+Ni (>10%) are used, Al+Si may not be used as there can be enough Mn and Ni in the final coating after oxidation takes place.

In some embodiments, the alloy can be described as having a austenitic (face centered cubic gamma phase) or semi-austenitic microstructure in both the ingot and as-sprayed form and having a composition of, in wt. %: Mn: 10-18, Cr: 3-6, Nb: 3-6, V: 0-5, C: 2-5, W: 3-6, Ni: 0-3, Al: 0-3 Ti: 0-0.5 with the balance being Fe along with manufacturing impurities (or Mn: about 10 to about 18, Cr: about 3 to about 6, Nb: about 3 to about 6, V: about 0 to about 5, C: about 2 to about 5, W: about 3 to about 6, Ni: about 0 to about 3, Al: about 0 to about 3, Ti: about 0 to about 0.5 with the balance being Fe along with manufacturing impurities).

In some embodiments, the alloy can be any of the followings in wt. %:
TS4: Fe: bal, Mn: 12, Cr: 5, Nb: 4, V: 0.5, C: 4, W: 5, Ni: 0, Al: 2, Ti: 0.2 (or Fe: bal, Mn: about 12, Cr: about 5, Nb: about 4, V: about 0.5, C: about 4, W: about 5, Ni: about 0, Al: about 2, Ti: about 0.2)
TS3: Fe: bal, Mn: 12, Cr: 5, Nb: 4, V: 0.5, C: 4, W: 5, Ni: 2, Al: 1, Ti: 0.2 (or Fe: bal, Mn: about 12, Cr: about 5, Nb: about 4, V: about 0.5, C: about 4, W: about 5, Ni: about 2, Al: about 1, Ti: about 0.2)
TS2: Fe: bal, Mn: 12, Cr: 5, Nb: 4, V: 0.5, C: 4, W: 5, Ni: 2, Al: 0, Ti: 0.2 (or Fe: bal, Mn: about 12, Cr: about 5, Nb: about 4, V: about 0.5, C: about 4, W: about 5, Ni: about 2, Al: about 0, Ti: about 0.2)
TS1: Fe: bal, Mn: 12, Cr: 5, Nb: 4, V: 0.5, C: 4, W: 5, Ni: 1, Al: 0, Ti: 0.2 (or Fe: bal, Mn: about 12, Cr: about 5, Nb: about 4, V: about 0.5, C: about 4, W: about 5, Ni: about 1, Al: about 0, Ti: about 0.2)

Furthermore, alloys which demonstrate certain thermodynamic embodiments, discussed below, and therefore likely meet the microstructural and performance embodiments are presented in Error! Not a valid bookmark self-reference.

TABLE 2
Alloys which meet thermodynamic embodiments

| No | Al | B | C | Mn | Ni | Si | FCC-BCC | Solid Strength |
|---|---|---|---|---|---|---|---|---|
| M1 | 0 | 0 | 4 | 0 | 8 | 0 | 950 | 8% |
| M2 | 0 | 0 | 4 | 0 | 8 | 2 | 950 | 12% |
| M3 | 0 | 0 | 4 | 0 | 8 | 4 | 950 | 10% |
| M4 | 0 | 0 | 4 | 0 | 8 | 6 | 950 | 16% |
| M5 | 0 | 0 | 4 | 0 | 8 | 8 | 950 | 22% |
| M6 | 0 | 0 | 4 | 0 | 10 | 0 | 900 | 10% |
| M7 | 0 | 0 | 4 | 0 | 10 | 2 | 900 | 14% |
| M8 | 0 | 0 | 4 | 0 | 10 | 4 | 950 | 12% |
| M9 | 0 | 0 | 4 | 0 | 10 | 6 | 950 | 18% |
| M10 | 0 | 0 | 4 | 0 | 10 | 8 | 950 | 24% |
| M11 | 0 | 0 | 4 | 0 | 10 | 10 | 950 | 27% |
| M12 | 0 | 0 | 4 | 0 | 12 | 0 | 900 | 12% |
| M13 | 0 | 0 | 4 | 0 | 12 | 2 | 900 | 16% |
| M14 | 0 | 0 | 4 | 0 | 12 | 4 | 900 | 14% |
| M15 | 0 | 0 | 4 | 0 | 12 | 6 | 900 | 21% |
| M16 | 0 | 0 | 4 | 0 | 12 | 8 | 950 | 26% |
| M17 | 0 | 0 | 4 | 0 | 12 | 10 | 950 | 29% |
| M18 | 0 | 0 | 4 | 0 | 14 | 0 | 850 | 14% |
| M19 | 0 | 0 | 4 | 0 | 14 | 2 | 850 | 18% |
| M20 | 0 | 0 | 4 | 0 | 14 | 4 | 900 | 16% |
| M21 | 0 | 0 | 4 | 0 | 14 | 6 | 900 | 23% |
| M22 | 0 | 0 | 4 | 0 | 14 | 8 | 900 | 28% |
| M23 | 0 | 0 | 4 | 0 | 14 | 10 | 950 | 31% |
| M24 | 0 | 0 | 4 | 0 | 16 | 0 | 850 | 16% |
| M25 | 0 | 0 | 4 | 0 | 16 | 2 | 850 | 20% |
| M26 | 0 | 0 | 4 | 0 | 16 | 4 | 850 | 18% |
| M27 | 0 | 0 | 4 | 0 | 16 | 6 | 900 | 25% |
| M28 | 0 | 0 | 4 | 0 | 16 | 8 | 900 | 31% |
| M29 | 0 | 0 | 4 | 0 | 16 | 10 | 900 | 33% |
| M30 | 0 | 0 | 4.4 | 0 | 8 | 0 | 950 | 8% |
| M31 | 0 | 0 | 4.4 | 0 | 8 | 2 | 950 | 9% |
| M32 | 0 | 0 | 4.4 | 0 | 8 | 4 | 950 | 10% |
| M33 | 0 | 0 | 4.4 | 0 | 8 | 6 | 950 | 18% |
| M34 | 0 | 0 | 4.4 | 0 | 8 | 8 | 950 | 23% |
| M35 | 0 | 0 | 4.4 | 0 | 10 | 0 | 900 | 10% |
| M36 | 0 | 0 | 4.4 | 0 | 10 | 2 | 900 | 11% |
| M37 | 0 | 0 | 4.4 | 0 | 10 | 4 | 950 | 13% |
| M38 | 0 | 0 | 4.4 | 0 | 10 | 6 | 950 | 20% |
| M39 | 0 | 0 | 4.4 | 0 | 10 | 8 | 950 | 26% |
| M40 | 0 | 0 | 4.4 | 0 | 10 | 10 | 950 | 28% |
| M41 | 0 | 0 | 4.4 | 0 | 12 | 0 | 900 | 12% |
| M42 | 0 | 0 | 4.4 | 0 | 12 | 2 | 900 | 13% |
| M43 | 0 | 0 | 4.4 | 0 | 12 | 4 | 900 | 15% |
| M44 | 0 | 0 | 4.4 | 0 | 12 | 6 | 900 | 22% |
| M45 | 0 | 0 | 4.4 | 0 | 12 | 8 | 950 | 28% |
| M46 | 0 | 0 | 4.4 | 0 | 12 | 10 | 950 | 30% |
| M47 | 0 | 0 | 4.4 | 0 | 14 | 0 | 850 | 14% |
| M48 | 0 | 0 | 4.4 | 0 | 14 | 2 | 850 | 15% |
| M49 | 0 | 0 | 4.4 | 0 | 14 | 4 | 900 | 18% |
| M50 | 0 | 0 | 4.4 | 0 | 14 | 6 | 900 | 24% |
| M51 | 0 | 0 | 4.4 | 0 | 14 | 8 | 900 | 30% |
| M52 | 0 | 0 | 4.4 | 0 | 14 | 10 | 950 | 32% |
| M53 | 0 | 0 | 4.4 | 0 | 16 | 0 | 850 | 16% |
| M54 | 0 | 0 | 4.4 | 0 | 16 | 2 | 850 | 17% |
| M55 | 0 | 0 | 4.4 | 0 | 16 | 4 | 850 | 20% |
| M56 | 0 | 0 | 4.4 | 0 | 16 | 6 | 900 | 26% |
| M57 | 0 | 0 | 4.4 | 0 | 16 | 8 | 900 | 32% |
| M58 | 0 | 0 | 4.4 | 0 | 16 | 10 | 900 | 34% |
| M59 | 0 | 0 | 4.8 | 0 | 8 | 0 | 950 | 8% |
| M60 | 0 | 0 | 4.8 | 0 | 8 | 2 | 950 | 9% |
| M61 | 0 | 0 | 4.8 | 0 | 8 | 4 | 950 | 12% |
| M62 | 0 | 0 | 4.8 | 0 | 8 | 6 | 950 | 19% |
| M63 | 0 | 0 | 4.8 | 0 | 8 | 8 | 950 | 25% |
| M64 | 0 | 0 | 4.8 | 0 | 10 | 0 | 900 | 10% |
| M65 | 0 | 0 | 4.8 | 0 | 10 | 2 | 900 | 11% |
| M66 | 0 | 0 | 4.8 | 0 | 10 | 4 | 950 | 15% |
| M67 | 0 | 0 | 4.8 | 0 | 10 | 6 | 950 | 21% |
| M68 | 0 | 0 | 4.8 | 0 | 10 | 8 | 950 | 27% |
| M69 | 0 | 0 | 4.8 | 0 | 10 | 10 | 950 | 29% |
| M70 | 0 | 0 | 4.8 | 0 | 12 | 0 | 900 | 12% |
| M71 | 0 | 0 | 4.8 | 0 | 12 | 2 | 900 | 13% |
| M72 | 0 | 0 | 4.8 | 0 | 12 | 4 | 900 | 17% |
| M73 | 0 | 0 | 4.8 | 0 | 12 | 6 | 900 | 24% |
| M74 | 0 | 0 | 4.8 | 0 | 12 | 8 | 950 | 29% |
| M75 | 0 | 0 | 4.8 | 0 | 12 | 10 | 950 | 31% |
| M76 | 0 | 0 | 4.8 | 0 | 14 | 0 | 850 | 14% |
| M77 | 0 | 0 | 4.8 | 0 | 14 | 2 | 850 | 15% |
| M78 | 0 | 0 | 4.8 | 0 | 14 | 4 | 900 | 19% |
| M79 | 0 | 0 | 4.8 | 0 | 14 | 6 | 900 | 26% |
| M80 | 0 | 0 | 4.8 | 0 | 14 | 8 | 900 | 31% |
| M81 | 0 | 0 | 4.8 | 0 | 14 | 10 | 950 | 33% |
| M82 | 0 | 0 | 4.8 | 0 | 16 | 0 | 850 | 16% |
| M83 | 0 | 0 | 4.8 | 0 | 16 | 2 | 850 | 17% |
| M84 | 0 | 0 | 4.8 | 0 | 16 | 4 | 850 | 21% |
| M85 | 0 | 0 | 4.8 | 0 | 16 | 6 | 900 | 28% |
| M86 | 0 | 0 | 4.8 | 0 | 16 | 8 | 900 | 33% |
| M87 | 0 | 0 | 4.8 | 0 | 16 | 10 | 900 | 35% |
| M88 | 0 | 0 | 5.2 | 0 | 8 | 0 | 950 | 8% |
| M89 | 0 | 0 | 5.2 | 0 | 8 | 2 | 950 | 9% |
| M90 | 0 | 0 | 5.2 | 0 | 8 | 4 | 950 | 14% |
| M91 | 0 | 0 | 5.2 | 0 | 8 | 6 | 950 | 21% |
| M92 | 0 | 0 | 5.2 | 0 | 8 | 8 | 950 | 26% |
| M93 | 0 | 0 | 5.2 | 0 | 10 | 0 | 900 | 11% |
| M94 | 0 | 0 | 5.2 | 0 | 10 | 2 | 900 | 11% |
| M95 | 0 | 0 | 5.2 | 0 | 10 | 4 | 950 | 16% |
| M96 | 0 | 0 | 5.2 | 0 | 10 | 6 | 950 | 23% |
| M97 | 0 | 0 | 5.2 | 0 | 10 | 8 | 950 | 28% |
| M98 | 0 | 0 | 5.2 | 0 | 10 | 10 | 950 | 31% |
| M99 | 0 | 0 | 5.2 | 0 | 12 | 0 | 900 | 13% |
| M100 | 0 | 0 | 5.2 | 0 | 12 | 2 | 900 | 13% |
| M101 | 0 | 0 | 5.2 | 0 | 12 | 4 | 900 | 18% |
| M102 | 0 | 0 | 5.2 | 0 | 12 | 6 | 900 | 25% |
| M103 | 0 | 0 | 5.2 | 0 | 12 | 8 | 950 | 30% |
| M104 | 0 | 0 | 5.2 | 0 | 12 | 10 | 950 | 33% |
| M105 | 0 | 0 | 5.2 | 0 | 14 | 0 | 850 | 15% |
| M106 | 0 | 0 | 5.2 | 0 | 14 | 2 | 850 | 15% |
| M107 | 0 | 0 | 5.2 | 0 | 14 | 4 | 900 | 21% |
| M108 | 0 | 0 | 5.2 | 0 | 14 | 6 | 900 | 27% |
| M109 | 0 | 0 | 5.2 | 0 | 14 | 8 | 900 | 32% |
| M110 | 0 | 0 | 5.2 | 0 | 14 | 10 | 950 | 35% |
| M111 | 0 | 0 | 5.2 | 0 | 16 | 0 | 850 | 17% |
| M112 | 0 | 0 | 5.2 | 0 | 16 | 2 | 850 | 18% |
| M113 | 0 | 0 | 5.2 | 0 | 16 | 4 | 850 | 23% |
| M114 | 0 | 0 | 5.2 | 0 | 16 | 6 | 900 | 29% |
| M115 | 0 | 0 | 5.2 | 0 | 16 | 8 | 900 | 34% |
| M116 | 0 | 0 | 5.2 | 0 | 16 | 10 | 900 | 37% |
| M117 | 0 | 0 | 5.6 | 0 | 8 | 0 | 950 | 9% |
| M118 | 0 | 0 | 5.6 | 0 | 8 | 2 | 950 | 9% |
| M119 | 0 | 0 | 5.6 | 0 | 8 | 4 | 950 | 16% |
| M120 | 0 | 0 | 5.6 | 0 | 8 | 6 | 950 | 22% |
| M121 | 0 | 0 | 5.6 | 0 | 8 | 8 | 950 | 27% |
| M122 | 0 | 0 | 5.6 | 0 | 10 | 0 | 900 | 11% |
| M123 | 0 | 0 | 5.6 | 0 | 10 | 2 | 900 | 12% |
| M124 | 0 | 0 | 5.6 | 0 | 10 | 4 | 900 | 18% |
| M125 | 0 | 0 | 5.6 | 0 | 10 | 6 | 950 | 24% |
| M126 | 0 | 0 | 5.6 | 0 | 10 | 8 | 950 | 30% |
| M127 | 0 | 0 | 5.6 | 0 | 10 | 10 | 950 | 32% |
| M128 | 0 | 0 | 5.6 | 0 | 12 | 0 | 900 | 13% |
| M129 | 0 | 0 | 5.6 | 0 | 12 | 2 | 900 | 14% |
| M130 | 0 | 0 | 5.6 | 0 | 12 | 4 | 900 | 20% |
| M131 | 0 | 0 | 5.6 | 0 | 12 | 6 | 900 | 26% |
| M132 | 0 | 0 | 5.6 | 0 | 12 | 8 | 900 | 32% |
| M133 | 0 | 0 | 5.6 | 0 | 12 | 10 | 950 | 34% |
| M134 | 0 | 0 | 5.6 | 0 | 14 | 0 | 850 | 15% |
| M135 | 0 | 0 | 5.6 | 0 | 14 | 2 | 850 | 16% |
| M136 | 0 | 0 | 5.6 | 0 | 14 | 4 | 900 | 22% |
| M137 | 0 | 0 | 5.6 | 0 | 14 | 6 | 900 | 29% |
| M138 | 0 | 0 | 5.6 | 0 | 14 | 8 | 900 | 34% |
| M139 | 0 | 0 | 5.6 | 0 | 14 | 10 | 900 | 36% |
| M140 | 0 | 0 | 5.6 | 0 | 16 | 0 | 850 | 17% |
| M141 | 0 | 0 | 5.6 | 0 | 16 | 2 | 850 | 18% |
| M142 | 0 | 0 | 5.6 | 0 | 16 | 4 | 850 | 25% |
| M143 | 0 | 0 | 5.6 | 0 | 16 | 6 | 900 | 31% |
| M144 | 0 | 0 | 5.6 | 0 | 16 | 8 | 900 | 36% |
| M145 | 0 | 0 | 5.6 | 0 | 16 | 10 | 900 | 38% |
| M146 | 0 | 0 | 6 | 0 | 8 | 0 | 950 | 9% |
| M147 | 0 | 0 | 6 | 0 | 8 | 2 | 950 | 10% |
| M148 | 0 | 0 | 6 | 0 | 8 | 4 | 950 | 17% |
| M149 | 0 | 0 | 6 | 0 | 8 | 6 | 950 | 24% |
| M150 | 0 | 0 | 6 | 0 | 8 | 8 | 950 | 29% |
| M151 | 0 | 0 | 6 | 0 | 10 | 0 | 900 | 11% |
| M152 | 0 | 0 | 6 | 0 | 10 | 2 | 900 | 12% |
| M153 | 0 | 0 | 6 | 0 | 10 | 4 | 900 | 19% |
| M154 | 0 | 0 | 6 | 0 | 10 | 6 | 950 | 26% |
| M155 | 0 | 0 | 6 | 0 | 10 | 8 | 950 | 31% |
| M156 | 0 | 0 | 6 | 0 | 10 | 10 | 950 | 33% |
| M157 | 0 | 0 | 6 | 0 | 12 | 0 | 900 | 13% |
| M158 | 0 | 0 | 6 | 0 | 12 | 2 | 900 | 15% |
| M159 | 0 | 0 | 6 | 0 | 12 | 4 | 900 | 22% |
| M160 | 0 | 0 | 6 | 0 | 12 | 6 | 900 | 28% |
| M161 | 0 | 0 | 6 | 0 | 12 | 8 | 900 | 33% |
| M162 | 0 | 0 | 6 | 0 | 12 | 10 | 950 | 35% |
| M163 | 0 | 0 | 6 | 0 | 14 | 0 | 850 | 15% |
| M164 | 0 | 0 | 6 | 0 | 14 | 2 | 850 | 17% |
| M165 | 0 | 0 | 6 | 0 | 14 | 4 | 900 | 24% |
| M166 | 0 | 0 | 6 | 0 | 14 | 6 | 900 | 30% |
| M167 | 0 | 0 | 6 | 0 | 14 | 8 | 900 | 35% |
| M168 | 0 | 0 | 6 | 0 | 14 | 10 | 900 | 37% |
| M169 | 0 | 0 | 6 | 0 | 16 | 0 | 850 | 17% |
| M170 | 0 | 0 | 6 | 0 | 16 | 2 | 850 | 19% |
| M171 | 0 | 0 | 6 | 0 | 16 | 4 | 850 | 26% |
| M172 | 0 | 0 | 6 | 0 | 16 | 6 | 850 | 32% |
| M173 | 0 | 0 | 6 | 0 | 16 | 8 | 900 | 37% |
| M174 | 0 | 0 | 6 | 0 | 16 | 10 | 900 | 39% |
| M175 | 2 | 0 | 4 | 0 | 8 | 0 | 950 | 9% |
| M176 | 2 | 0 | 4 | 0 | 8 | 2 | 950 | 9% |
| M177 | 2 | 0 | 4 | 0 | 8 | 4 | 950 | 15% |
| M178 | 2 | 0 | 4 | 0 | 8 | 6 | 950 | 21% |
| M179 | 2 | 0 | 4 | 0 | 10 | 0 | 900 | 11% |
| M180 | 2 | 0 | 4 | 0 | 10 | 2 | 900 | 11% |
| M181 | 2 | 0 | 4 | 0 | 10 | 4 | 950 | 17% |
| M182 | 2 | 0 | 4 | 0 | 10 | 6 | 950 | 23% |
| M183 | 2 | 0 | 4 | 0 | 10 | 8 | 950 | 26% |
| M184 | 2 | 0 | 4 | 0 | 12 | 0 | 900 | 13% |
| M185 | 2 | 0 | 4 | 0 | 12 | 2 | 900 | 14% |
| M186 | 2 | 0 | 4 | 0 | 12 | 4 | 900 | 19% |
| M187 | 2 | 0 | 4 | 0 | 12 | 6 | 900 | 26% |
| M188 | 2 | 0 | 4 | 0 | 12 | 8 | 950 | 28% |
| M189 | 2 | 0 | 4 | 0 | 14 | 0 | 850 | 15% |
| M190 | 2 | 0 | 4 | 0 | 14 | 2 | 900 | 16% |
| M191 | 2 | 0 | 4 | 0 | 14 | 4 | 900 | 21% |
| M192 | 2 | 0 | 4 | 0 | 14 | 6 | 900 | 28% |
| M193 | 2 | 0 | 4 | 0 | 14 | 8 | 900 | 31% |
| M194 | 2 | 0 | 4 | 0 | 14 | 10 | 950 | 33% |
| M195 | 2 | 0 | 4 | 0 | 16 | 0 | 850 | 17% |
| M196 | 2 | 0 | 4 | 0 | 16 | 2 | 850 | 18% |
| M197 | 2 | 0 | 4 | 0 | 16 | 4 | 850 | 24% |
| M198 | 2 | 0 | 4 | 0 | 16 | 6 | 900 | 30% |
| M199 | 2 | 0 | 4 | 0 | 16 | 8 | 900 | 33% |
| M200 | 2 | 0 | 4 | 0 | 16 | 10 | 950 | 35% |
| M201 | 2 | 0 | 4.4 | 0 | 8 | 0 | 950 | 9% |
| M202 | 2 | 0 | 4.4 | 0 | 8 | 2 | 950 | 10% |
| M203 | 2 | 0 | 4.4 | 0 | 8 | 4 | 950 | 16% |
| M204 | 2 | 0 | 4.4 | 0 | 8 | 6 | 950 | 23% |
| M205 | 2 | 0 | 4.4 | 0 | 10 | 0 | 900 | 11% |
| M206 | 2 | 0 | 4.4 | 0 | 10 | 2 | 900 | 12% |
| M207 | 2 | 0 | 4.4 | 0 | 10 | 4 | 950 | 18% |
| M208 | 2 | 0 | 4.4 | 0 | 10 | 6 | 950 | 25% |
| M209 | 2 | 0 | 4.4 | 0 | 10 | 8 | 950 | 28% |
| M210 | 2 | 0 | 4.4 | 0 | 12 | 0 | 900 | 13% |
| M211 | 2 | 0 | 4.4 | 0 | 12 | 2 | 900 | 14% |
| M212 | 2 | 0 | 4.4 | 0 | 12 | 4 | 900 | 21% |
| M213 | 2 | 0 | 4.4 | 0 | 12 | 6 | 900 | 27% |
| M214 | 2 | 0 | 4.4 | 0 | 12 | 8 | 950 | 30% |
| M215 | 2 | 0 | 4.4 | 0 | 14 | 0 | 850 | 15% |
| M216 | 2 | 0 | 4.4 | 0 | 14 | 2 | 900 | 16% |
| M217 | 2 | 0 | 4.4 | 0 | 14 | 4 | 900 | 23% |
| M218 | 2 | 0 | 4.4 | 0 | 14 | 6 | 900 | 29% |
| M219 | 2 | 0 | 4.4 | 0 | 14 | 8 | 900 | 32% |
| M220 | 2 | 0 | 4.4 | 0 | 14 | 10 | 950 | 34% |
| M221 | 2 | 0 | 4.4 | 0 | 16 | 0 | 850 | 18% |
| M222 | 2 | 0 | 4.4 | 0 | 16 | 2 | 850 | 18% |
| M223 | 2 | 0 | 4.4 | 0 | 16 | 4 | 850 | 25% |
| M224 | 2 | 0 | 4.4 | 0 | 16 | 6 | 900 | 31% |
| M225 | 2 | 0 | 4.4 | 0 | 16 | 8 | 900 | 34% |
| M226 | 2 | 0 | 4.4 | 0 | 16 | 10 | 950 | 36% |
| M227 | 2 | 0 | 4.8 | 0 | 8 | 0 | 950 | 9% |
| M228 | 2 | 0 | 4.8 | 0 | 8 | 2 | 950 | 11% |
| M229 | 2 | 0 | 4.8 | 0 | 8 | 4 | 950 | 18% |
| M230 | 2 | 0 | 4.8 | 0 | 8 | 6 | 950 | 24% |
| M231 | 2 | 0 | 4.8 | 0 | 10 | 0 | 900 | 11% |
| M232 | 2 | 0 | 4.8 | 0 | 10 | 2 | 900 | 13% |
| M233 | 2 | 0 | 4.8 | 0 | 10 | 4 | 950 | 20% |
| M234 | 2 | 0 | 4.8 | 0 | 10 | 6 | 950 | 26% |
| M235 | 2 | 0 | 4.8 | 0 | 10 | 8 | 950 | 29% |
| M236 | 2 | 0 | 4.8 | 0 | 12 | 0 | 900 | 13% |
| M237 | 2 | 0 | 4.8 | 0 | 12 | 2 | 900 | 15% |
| M238 | 2 | 0 | 4.8 | 0 | 12 | 4 | 900 | 22% |
| M239 | 2 | 0 | 4.8 | 0 | 12 | 6 | 900 | 28% |
| M240 | 2 | 0 | 4.8 | 0 | 12 | 8 | 950 | 31% |
| M241 | 2 | 0 | 4.8 | 0 | 14 | 0 | 850 | 15% |
| M242 | 2 | 0 | 4.8 | 0 | 14 | 2 | 900 | 18% |
| M243 | 2 | 0 | 4.8 | 0 | 14 | 4 | 900 | 25% |
| M244 | 2 | 0 | 4.8 | 0 | 14 | 6 | 900 | 31% |
| M245 | 2 | 0 | 4.8 | 0 | 14 | 8 | 900 | 33% |
| M246 | 2 | 0 | 4.8 | 0 | 14 | 10 | 950 | 35% |
| M247 | 2 | 0 | 4.8 | 0 | 16 | 0 | 850 | 17% |
| M248 | 2 | 0 | 4.8 | 0 | 16 | 2 | 850 | 20% |
| M249 | 2 | 0 | 4.8 | 0 | 16 | 4 | 850 | 27% |
| M250 | 2 | 0 | 4.8 | 0 | 16 | 6 | 900 | 33% |
| M251 | 2 | 0 | 4.8 | 0 | 16 | 8 | 900 | 35% |
| M252 | 2 | 0 | 4.8 | 0 | 16 | 10 | 950 | 37% |
| M253 | 2 | 0 | 5.2 | 0 | 8 | 0 | 950 | 9% |
| M254 | 2 | 0 | 5.2 | 0 | 8 | 2 | 950 | 12% |
| M255 | 2 | 0 | 5.2 | 0 | 8 | 4 | 950 | 19% |
| M256 | 2 | 0 | 5.2 | 0 | 8 | 6 | 950 | 26% |
| M257 | 2 | 0 | 5.2 | 0 | 10 | 0 | 900 | 11% |
| M258 | 2 | 0 | 5.2 | 0 | 10 | 2 | 900 | 15% |
| M259 | 2 | 0 | 5.2 | 0 | 10 | 4 | 950 | 22% |
| M260 | 2 | 0 | 5.2 | 0 | 10 | 6 | 950 | 28% |
| M261 | 2 | 0 | 5.2 | 0 | 10 | 8 | 950 | 30% |
| M262 | 2 | 0 | 5.2 | 0 | 12 | 0 | 900 | 13% |
| M263 | 2 | 0 | 5.2 | 0 | 12 | 2 | 900 | 17% |
| M264 | 2 | 0 | 5.2 | 0 | 12 | 4 | 900 | 24% |
| M265 | 2 | 0 | 5.2 | 0 | 12 | 6 | 900 | 30% |
| M266 | 2 | 0 | 5.2 | 0 | 12 | 8 | 950 | 32% |
| M267 | 2 | 0 | 5.2 | 0 | 14 | 0 | 850 | 15% |
| M268 | 2 | 0 | 5.2 | 0 | 14 | 2 | 900 | 19% |
| M269 | 2 | 0 | 5.2 | 0 | 14 | 4 | 900 | 26% |
| M270 | 2 | 0 | 5.2 | 0 | 14 | 6 | 900 | 32% |
| M271 | 2 | 0 | 5.2 | 0 | 14 | 8 | 900 | 34% |
| M272 | 2 | 0 | 5.2 | 0 | 14 | 10 | 950 | 37% |
| M273 | 2 | 0 | 5.2 | 0 | 16 | 0 | 850 | 17% |
| M274 | 2 | 0 | 5.2 | 0 | 16 | 2 | 850 | 22% |
| M275 | 2 | 0 | 5.2 | 0 | 16 | 4 | 850 | 28% |
| M276 | 2 | 0 | 5.2 | 0 | 16 | 6 | 900 | 34% |
| M277 | 2 | 0 | 5.2 | 0 | 16 | 8 | 900 | 36% |
| M278 | 2 | 0 | 5.2 | 0 | 16 | 10 | 950 | 38% |
| M279 | 2 | 0 | 5.6 | 0 | 8 | 0 | 950 | 9% |
| M280 | 2 | 0 | 5.6 | 0 | 8 | 2 | 950 | 14% |
| M281 | 2 | 0 | 5.6 | 0 | 8 | 4 | 950 | 21% |
| M282 | 2 | 0 | 5.6 | 0 | 8 | 6 | 950 | 27% |
| M283 | 2 | 0 | 5.6 | 0 | 10 | 0 | 900 | 11% |
| M284 | 2 | 0 | 5.6 | 0 | 10 | 2 | 900 | 16% |
| M285 | 2 | 0 | 5.6 | 0 | 10 | 4 | 950 | 23% |
| M286 | 2 | 0 | 5.6 | 0 | 10 | 6 | 950 | 29% |
| M287 | 2 | 0 | 5.6 | 0 | 10 | 8 | 950 | 32% |
| M288 | 2 | 0 | 5.6 | 0 | 12 | 0 | 900 | 13% |
| M289 | 2 | 0 | 5.6 | 0 | 12 | 2 | 900 | 19% |
| M290 | 2 | 0 | 5.6 | 0 | 12 | 4 | 900 | 25% |
| M291 | 2 | 0 | 5.6 | 0 | 12 | 6 | 900 | 31% |
| M292 | 2 | 0 | 5.6 | 0 | 12 | 8 | 950 | 34% |
| M293 | 2 | 0 | 5.6 | 0 | 14 | 0 | 850 | 16% |
| M294 | 2 | 0 | 5.6 | 0 | 14 | 2 | 900 | 21% |
| M295 | 2 | 0 | 5.6 | 0 | 14 | 4 | 900 | 27% |
| M296 | 2 | 0 | 5.6 | 0 | 14 | 6 | 900 | 33% |
| M297 | 2 | 0 | 5.6 | 0 | 14 | 8 | 900 | 36% |
| M298 | 2 | 0 | 5.6 | 0 | 14 | 10 | 950 | 38% |
| M299 | 2 | 0 | 5.6 | 0 | 16 | 0 | 850 | 18% |
| M300 | 2 | 0 | 5.6 | 0 | 16 | 2 | 850 | 23% |
| M301 | 2 | 0 | 5.6 | 0 | 16 | 4 | 850 | 30% |
| M302 | 2 | 0 | 5.6 | 0 | 16 | 6 | 900 | 35% |
| M303 | 2 | 0 | 5.6 | 0 | 16 | 8 | 900 | 38% |
| M304 | 2 | 0 | 5.6 | 0 | 16 | 10 | 950 | 40% |
| M305 | 2 | 0 | 6 | 0 | 8 | 0 | 950 | 10% |
| M306 | 2 | 0 | 6 | 0 | 8 | 2 | 950 | 16% |
| M307 | 2 | 0 | 6 | 0 | 8 | 4 | 950 | 22% |
| M308 | 2 | 0 | 6 | 0 | 8 | 6 | 950 | 28% |
| M309 | 2 | 0 | 6 | 0 | 10 | 0 | 900 | 12% |
| M310 | 2 | 0 | 6 | 0 | 10 | 2 | 900 | 18% |
| M311 | 2 | 0 | 6 | 0 | 10 | 4 | 950 | 24% |
| M312 | 2 | 0 | 6 | 0 | 10 | 6 | 950 | 30% |
| M313 | 2 | 0 | 6 | 0 | 10 | 8 | 950 | 33% |
| M314 | 2 | 0 | 6 | 0 | 12 | 0 | 900 | 14% |
| M315 | 2 | 0 | 6 | 0 | 12 | 2 | 900 | 20% |
| M316 | 2 | 0 | 6 | 0 | 12 | 4 | 900 | 27% |
| M317 | 2 | 0 | 6 | 0 | 12 | 6 | 900 | 32% |
| M318 | 2 | 0 | 6 | 0 | 12 | 8 | 950 | 35% |
| M319 | 2 | 0 | 6 | 0 | 14 | 0 | 850 | 16% |
| M320 | 2 | 0 | 6 | 0 | 14 | 2 | 900 | 23% |
| M321 | 2 | 0 | 6 | 0 | 14 | 4 | 900 | 29% |
| M322 | 2 | 0 | 6 | 0 | 14 | 6 | 900 | 34% |
| M323 | 2 | 0 | 6 | 0 | 14 | 8 | 900 | 37% |
| M324 | 2 | 0 | 6 | 0 | 14 | 10 | 950 | 39% |
| M325 | 2 | 0 | 6 | 0 | 16 | 0 | 850 | 18% |
| M326 | 2 | 0 | 6 | 0 | 16 | 2 | 850 | 25% |
| M327 | 2 | 0 | 6 | 0 | 16 | 4 | 850 | 31% |
| M328 | 2 | 0 | 6 | 0 | 16 | 6 | 900 | 36% |
| M329 | 2 | 0 | 6 | 0 | 16 | 8 | 900 | 39% |
| M330 | 2 | 0 | 6 | 0 | 16 | 10 | 950 | 41% |
| M331 | 4 | 0 | 4 | 0 | 8 | 0 | 950 | 9% |
| M332 | 4 | 0 | 4 | 0 | 8 | 2 | 950 | 13% |
| M333 | 4 | 0 | 4 | 0 | 8 | 4 | 950 | 20% |
| M334 | 4 | 0 | 4 | 0 | 10 | 0 | 900 | 11% |
| M335 | 4 | 0 | 4 | 0 | 10 | 2 | 950 | 15% |
| M336 | 4 | 0 | 4 | 0 | 10 | 4 | 950 | 22% |
| M337 | 4 | 0 | 4 | 0 | 10 | 6 | 950 | 26% |
| M338 | 4 | 0 | 4 | 0 | 12 | 0 | 900 | 13% |
| M339 | 4 | 0 | 4 | 0 | 12 | 2 | 900 | 18% |
| M340 | 4 | 0 | 4 | 0 | 12 | 4 | 900 | 24% |
| M341 | 4 | 0 | 4 | 0 | 12 | 6 | 950 | 28% |
| M342 | 4 | 0 | 4 | 0 | 14 | 0 | 900 | 15% |
| M343 | 4 | 0 | 4 | 0 | 14 | 2 | 900 | 20% |
| M344 | 4 | 0 | 4 | 0 | 14 | 4 | 900 | 27% |
| M345 | 4 | 0 | 4 | 0 | 14 | 6 | 900 | 30% |
| M346 | 4 | 0 | 4 | 0 | 14 | 8 | 950 | 33% |
| M347 | 4 | 0 | 4 | 0 | 16 | 0 | 850 | 18% |
| M348 | 4 | 0 | 4 | 0 | 16 | 2 | 850 | 22% |
| M349 | 4 | 0 | 4 | 0 | 16 | 4 | 900 | 29% |
| M350 | 4 | 0 | 4 | 0 | 16 | 6 | 900 | 32% |
| M351 | 4 | 0 | 4 | 0 | 16 | 8 | 900 | 35% |
| M352 | 4 | 0 | 4.4 | 0 | 8 | 0 | 950 | 9% |
| M353 | 4 | 0 | 4.4 | 0 | 8 | 2 | 950 | 15% |
| M354 | 4 | 0 | 4.4 | 0 | 8 | 4 | 950 | 21% |
| M355 | 4 | 0 | 4.4 | 0 | 10 | 0 | 900 | 11% |
| M356 | 4 | 0 | 4.4 | 0 | 10 | 2 | 950 | 17% |
| M357 | 4 | 0 | 4.4 | 0 | 10 | 4 | 950 | 24% |
| M358 | 4 | 0 | 4.4 | 0 | 10 | 6 | 950 | 27% |
| M359 | 4 | 0 | 4.4 | 0 | 12 | 0 | 900 | 14% |
| M360 | 4 | 0 | 4.4 | 0 | 12 | 2 | 900 | 19% |
| M361 | 4 | 0 | 4.4 | 0 | 12 | 4 | 900 | 26% |
| M362 | 4 | 0 | 4.4 | 0 | 12 | 6 | 950 | 29% |
| M363 | 4 | 0 | 4.4 | 0 | 14 | 0 | 900 | 16% |
| M364 | 4 | 0 | 4.4 | 0 | 14 | 2 | 900 | 22% |
| M365 | 4 | 0 | 4.4 | 0 | 14 | 4 | 900 | 28% |
| M366 | 4 | 0 | 4.4 | 0 | 14 | 6 | 900 | 31% |
| M367 | 4 | 0 | 4.4 | 0 | 14 | 8 | 950 | 34% |
| M368 | 4 | 0 | 4.4 | 0 | 16 | 0 | 850 | 18% |
| M369 | 4 | 0 | 4.4 | 0 | 16 | 2 | 850 | 24% |
| M370 | 4 | 0 | 4.4 | 0 | 16 | 4 | 900 | 30% |
| M371 | 4 | 0 | 4.4 | 0 | 16 | 6 | 900 | 34% |
| M372 | 4 | 0 | 4.4 | 0 | 16 | 8 | 900 | 36% |
| M373 | 4 | 0 | 4.8 | 0 | 8 | 0 | 950 | 10% |
| M374 | 4 | 0 | 4.8 | 0 | 8 | 2 | 950 | 16% |
| M375 | 4 | 0 | 4.8 | 0 | 8 | 4 | 950 | 23% |
| M376 | 4 | 0 | 4.8 | 0 | 10 | 0 | 900 | 12% |
| M377 | 4 | 0 | 4.8 | 0 | 10 | 2 | 950 | 19% |
| M378 | 4 | 0 | 4.8 | 0 | 10 | 4 | 950 | 25% |
| M379 | 4 | 0 | 4.8 | 0 | 10 | 6 | 950 | 29% |
| M380 | 4 | 0 | 4.8 | 0 | 12 | 0 | 900 | 14% |
| M381 | 4 | 0 | 4.8 | 0 | 12 | 2 | 900 | 21% |
| M382 | 4 | 0 | 4.8 | 0 | 12 | 4 | 900 | 27% |
| M383 | 4 | 0 | 4.8 | 0 | 12 | 6 | 950 | 31% |
| M384 | 4 | 0 | 4.8 | 0 | 14 | 0 | 900 | 16% |
| M385 | 4 | 0 | 4.8 | 0 | 14 | 2 | 900 | 23% |
| M386 | 4 | 0 | 4.8 | 0 | 14 | 4 | 900 | 29% |
| M387 | 4 | 0 | 4.8 | 0 | 14 | 6 | 900 | 33% |
| M388 | 4 | 0 | 4.8 | 0 | 14 | 8 | 950 | 35% |
| M389 | 4 | 0 | 4.8 | 0 | 16 | 0 | 850 | 19% |
| M390 | 4 | 0 | 4.8 | 0 | 16 | 2 | 850 | 25% |
| M391 | 4 | 0 | 4.8 | 0 | 16 | 4 | 900 | 32% |
| M392 | 4 | 0 | 4.8 | 0 | 16 | 6 | 900 | 35% |
| M393 | 4 | 0 | 4.8 | 0 | 16 | 8 | 900 | 37% |
| M394 | 4 | 0 | 5.2 | 0 | 8 | 0 | 950 | 11% |
| M395 | 4 | 0 | 5.2 | 0 | 8 | 2 | 950 | 18% |
| M396 | 4 | 0 | 5.2 | 0 | 8 | 4 | 950 | 24% |
| M397 | 4 | 0 | 5.2 | 0 | 10 | 0 | 900 | 13% |
| M398 | 4 | 0 | 5.2 | 0 | 10 | 2 | 950 | 20% |
| M399 | 4 | 0 | 5.2 | 0 | 10 | 4 | 950 | 27% |
| M400 | 4 | 0 | 5.2 | 0 | 10 | 6 | 950 | 30% |
| M401 | 4 | 0 | 5.2 | 0 | 12 | 0 | 900 | 16% |
| M402 | 4 | 0 | 5.2 | 0 | 12 | 2 | 900 | 22% |
| M403 | 4 | 0 | 5.2 | 0 | 12 | 4 | 900 | 29% |
| M404 | 4 | 0 | 5.2 | 0 | 12 | 6 | 950 | 32% |
| M405 | 4 | 0 | 5.2 | 0 | 14 | 0 | 900 | 18% |
| M406 | 4 | 0 | 5.2 | 0 | 14 | 2 | 900 | 25% |
| M407 | 4 | 0 | 5.2 | 0 | 14 | 4 | 900 | 31% |
| M408 | 4 | 0 | 5.2 | 0 | 14 | 6 | 900 | 34% |
| M409 | 4 | 0 | 5.2 | 0 | 14 | 8 | 950 | 36% |
| M410 | 4 | 0 | 5.2 | 0 | 16 | 0 | 850 | 20% |
| M411 | 4 | 0 | 5.2 | 0 | 16 | 2 | 850 | 27% |
| M412 | 4 | 0 | 5.2 | 0 | 16 | 4 | 900 | 33% |
| M413 | 4 | 0 | 5.2 | 0 | 16 | 6 | 900 | 36% |
| M414 | 4 | 0 | 5.2 | 0 | 16 | 8 | 900 | 38% |
| M415 | 4 | 0 | 5.6 | 0 | 8 | 0 | 950 | 13% |
| M416 | 4 | 0 | 5.6 | 0 | 8 | 2 | 950 | 20% |
| M417 | 4 | 0 | 5.6 | 0 | 8 | 4 | 950 | 26% |
| M418 | 4 | 0 | 5.6 | 0 | 10 | 0 | 900 | 15% |
| M419 | 4 | 0 | 5.6 | 0 | 10 | 2 | 950 | 22% |
| M420 | 4 | 0 | 5.6 | 0 | 10 | 4 | 950 | 28% |
| M421 | 4 | 0 | 5.6 | 0 | 10 | 6 | 950 | 31% |
| M422 | 4 | 0 | 5.6 | 0 | 12 | 0 | 900 | 17% |
| M423 | 4 | 0 | 5.6 | 0 | 12 | 2 | 900 | 24% |
| M424 | 4 | 0 | 5.6 | 0 | 12 | 4 | 900 | 30% |
| M425 | 4 | 0 | 5.6 | 0 | 12 | 6 | 950 | 33% |
| M426 | 4 | 0 | 5.6 | 0 | 14 | 0 | 900 | 20% |
| M427 | 4 | 0 | 5.6 | 0 | 14 | 2 | 900 | 26% |
| M428 | 4 | 0 | 5.6 | 0 | 14 | 4 | 900 | 32% |
| M429 | 4 | 0 | 5.6 | 0 | 14 | 6 | 900 | 35% |
| M430 | 4 | 0 | 5.6 | 0 | 14 | 8 | 950 | 37% |
| M431 | 4 | 0 | 5.6 | 0 | 16 | 0 | 850 | 22% |
| M432 | 4 | 0 | 5.6 | 0 | 16 | 2 | 850 | 28% |
| M433 | 4 | 0 | 5.6 | 0 | 16 | 4 | 900 | 34% |
| M434 | 4 | 0 | 5.6 | 0 | 16 | 6 | 900 | 37% |
| M435 | 4 | 0 | 5.6 | 0 | 16 | 8 | 900 | 39% |
| M436 | 4 | 0 | 6 | 0 | 8 | 0 | 950 | 14% |
| M437 | 4 | 0 | 6 | 0 | 8 | 2 | 950 | 21% |
| M438 | 4 | 0 | 6 | 0 | 8 | 4 | 950 | 27% |
| M439 | 4 | 0 | 6 | 0 | 10 | 0 | 900 | 17% |
| M440 | 4 | 0 | 6 | 0 | 10 | 2 | 950 | 23% |
| M441 | 4 | 0 | 6 | 0 | 10 | 4 | 950 | 29% |
| M442 | 4 | 0 | 6 | 0 | 10 | 6 | 950 | 32% |
| M443 | 4 | 0 | 6 | 0 | 12 | 0 | 900 | 19% |
| M444 | 4 | 0 | 6 | 0 | 12 | 2 | 900 | 25% |
| M445 | 4 | 0 | 6 | 0 | 12 | 4 | 900 | 31% |
| M446 | 4 | 0 | 6 | 0 | 12 | 6 | 950 | 34% |
| M447 | 4 | 0 | 6 | 0 | 14 | 0 | 900 | 21% |
| M448 | 4 | 0 | 6 | 0 | 14 | 2 | 900 | 28% |
| M449 | 4 | 0 | 6 | 0 | 14 | 4 | 900 | 33% |
| M450 | 4 | 0 | 6 | 0 | 14 | 6 | 900 | 36% |
| M451 | 4 | 0 | 6 | 0 | 14 | 8 | 950 | 39% |
| M452 | 4 | 0 | 6 | 0 | 16 | 0 | 850 | 23% |
| M453 | 4 | 0 | 6 | 0 | 16 | 2 | 850 | 30% |
| M454 | 4 | 0 | 6 | 0 | 16 | 4 | 900 | 35% |
| M455 | 4 | 0 | 6 | 0 | 16 | 6 | 900 | 38% |
| M456 | 4 | 0 | 6 | 0 | 16 | 8 | 900 | 40% |
| M457 | 6 | 0 | 4 | 0 | 8 | 0 | 950 | 11% |
| M458 | 6 | 0 | 4 | 0 | 8 | 2 | 950 | 19% |
| M459 | 6 | 0 | 4 | 0 | 8 | 4 | 950 | 23% |
| M460 | 6 | 0 | 4 | 0 | 10 | 0 | 950 | 14% |
| M461 | 6 | 0 | 4 | 0 | 10 | 2 | 950 | 21% |
| M462 | 6 | 0 | 4 | 0 | 10 | 4 | 950 | 25% |
| M463 | 6 | 0 | 4 | 0 | 12 | 0 | 900 | 16% |
| M464 | 6 | 0 | 4 | 0 | 12 | 2 | 900 | 23% |
| M465 | 6 | 0 | 4 | 0 | 12 | 4 | 950 | 28% |
| M466 | 6 | 0 | 4 | 0 | 12 | 6 | 950 | 30% |
| M467 | 6 | 0 | 4 | 0 | 14 | 0 | 900 | 19% |
| M468 | 6 | 0 | 4 | 0 | 14 | 2 | 900 | 25% |
| M469 | 6 | 0 | 4 | 0 | 14 | 4 | 900 | 30% |
| M470 | 6 | 0 | 4 | 0 | 14 | 6 | 950 | 32% |
| M471 | 6 | 0 | 4 | 0 | 16 | 0 | 850 | 21% |
| M472 | 6 | 0 | 4 | 0 | 16 | 2 | 900 | 28% |
| M473 | 6 | 0 | 4 | 0 | 16 | 4 | 900 | 32% |
| M474 | 6 | 0 | 4 | 0 | 16 | 6 | 900 | 34% |
| M475 | 6 | 0 | 4.4 | 0 | 8 | 0 | 950 | 13% |
| M476 | 6 | 0 | 4.4 | 0 | 8 | 2 | 950 | 20% |
| M477 | 6 | 0 | 4.4 | 0 | 8 | 4 | 950 | 25% |
| M478 | 6 | 0 | 4.4 | 0 | 10 | 0 | 950 | 16% |
| M479 | 6 | 0 | 4.4 | 0 | 10 | 2 | 950 | 22% |
| M480 | 6 | 0 | 4.4 | 0 | 10 | 4 | 950 | 27% |
| M481 | 6 | 0 | 4.4 | 0 | 12 | 0 | 900 | 18% |
| M482 | 6 | 0 | 4.4 | 0 | 12 | 2 | 900 | 25% |
| M483 | 6 | 0 | 4.4 | 0 | 12 | 4 | 950 | 29% |
| M484 | 6 | 0 | 4.4 | 0 | 12 | 6 | 950 | 31% |
| M485 | 6 | 0 | 4.4 | 0 | 14 | 0 | 900 | 20% |
| M486 | 6 | 0 | 4.4 | 0 | 14 | 2 | 900 | 27% |
| M487 | 6 | 0 | 4.4 | 0 | 14 | 4 | 900 | 31% |
| M488 | 6 | 0 | 4.4 | 0 | 14 | 6 | 950 | 33% |
| M489 | 6 | 0 | 4.4 | 0 | 16 | 0 | 850 | 23% |
| M490 | 6 | 0 | 4.4 | 0 | 16 | 2 | 900 | 29% |
| M491 | 6 | 0 | 4.4 | 0 | 16 | 4 | 900 | 33% |
| M492 | 6 | 0 | 4.4 | 0 | 16 | 6 | 900 | 35% |
| M493 | 6 | 0 | 4.8 | 0 | 8 | 0 | 950 | 15% |
| M494 | 6 | 0 | 4.8 | 0 | 8 | 2 | 950 | 22% |
| M495 | 6 | 0 | 4.8 | 0 | 8 | 4 | 950 | 26% |
| M496 | 6 | 0 | 4.8 | 0 | 10 | 0 | 950 | 17% |
| M497 | 6 | 0 | 4.8 | 0 | 10 | 2 | 950 | 24% |
| M498 | 6 | 0 | 4.8 | 0 | 10 | 4 | 950 | 28% |
| M499 | 6 | 0 | 4.8 | 0 | 12 | 0 | 900 | 20% |
| M500 | 6 | 0 | 4.8 | 0 | 12 | 2 | 900 | 26% |
| M501 | 6 | 0 | 4.8 | 0 | 12 | 4 | 950 | 30% |
| M502 | 6 | 0 | 4.8 | 0 | 12 | 6 | 950 | 33% |
| M503 | 6 | 0 | 4.8 | 0 | 14 | 0 | 900 | 22% |
| M504 | 6 | 0 | 4.8 | 0 | 14 | 2 | 900 | 28% |
| M505 | 6 | 0 | 4.8 | 0 | 14 | 4 | 900 | 32% |
| M506 | 6 | 0 | 4.8 | 0 | 14 | 6 | 950 | 35% |
| M507 | 6 | 0 | 4.8 | 0 | 16 | 0 | 850 | 24% |
| M508 | 6 | 0 | 4.8 | 0 | 16 | 2 | 900 | 30% |
| M509 | 6 | 0 | 4.8 | 0 | 16 | 4 | 900 | 34% |
| M510 | 6 | 0 | 4.8 | 0 | 16 | 6 | 900 | 37% |
| M511 | 6 | 0 | 5.2 | 0 | 8 | 0 | 950 | 17% |
| M512 | 6 | 0 | 5.2 | 0 | 8 | 2 | 950 | 23% |
| M513 | 6 | 0 | 5.2 | 0 | 8 | 4 | 950 | 27% |
| M514 | 6 | 0 | 5.2 | 0 | 10 | 0 | 950 | 19% |
| M515 | 6 | 0 | 5.2 | 0 | 10 | 2 | 950 | 25% |
| M516 | 6 | 0 | 5.2 | 0 | 10 | 4 | 950 | 29% |
| M517 | 6 | 0 | 5.2 | 0 | 12 | 0 | 900 | 21% |
| M518 | 6 | 0 | 5.2 | 0 | 12 | 2 | 900 | 27% |
| M519 | 6 | 0 | 5.2 | 0 | 12 | 4 | 950 | 32% |
| M520 | 6 | 0 | 5.2 | 0 | 12 | 6 | 950 | 34% |
| M521 | 6 | 0 | 5.2 | 0 | 14 | 0 | 900 | 23% |
| M522 | 6 | 0 | 5.2 | 0 | 14 | 2 | 900 | 30% |
| M523 | 6 | 0 | 5.2 | 0 | 14 | 4 | 900 | 34% |
| M524 | 6 | 0 | 5.2 | 0 | 14 | 6 | 950 | 36% |
| M525 | 6 | 0 | 5.2 | 0 | 16 | 0 | 850 | 26% |
| M526 | 6 | 0 | 5.2 | 0 | 16 | 2 | 900 | 32% |
| M527 | 6 | 0 | 5.2 | 0 | 16 | 4 | 900 | 36% |
| M528 | 6 | 0 | 5.2 | 0 | 16 | 6 | 900 | 38% |
| M529 | 6 | 0 | 5.6 | 0 | 8 | 0 | 950 | 18% |
| M530 | 6 | 0 | 5.6 | 0 | 8 | 2 | 950 | 25% |
| M531 | 6 | 0 | 5.6 | 0 | 8 | 4 | 950 | 29% |
| M532 | 6 | 0 | 5.6 | 0 | 10 | 0 | 950 | 20% |
| M533 | 6 | 0 | 5.6 | 0 | 10 | 2 | 950 | 27% |
| M534 | 6 | 0 | 5.6 | 0 | 10 | 4 | 950 | 31% |
| M535 | 6 | 0 | 5.6 | 0 | 12 | 0 | 900 | 23% |
| M536 | 6 | 0 | 5.6 | 0 | 12 | 2 | 900 | 29% |
| M537 | 6 | 0 | 5.6 | 0 | 12 | 4 | 950 | 33% |
| M538 | 6 | 0 | 5.6 | 0 | 12 | 6 | 950 | 35% |
| M539 | 6 | 0 | 5.6 | 0 | 14 | 0 | 900 | 25% |
| M540 | 6 | 0 | 5.6 | 0 | 14 | 2 | 900 | 31% |
| M541 | 6 | 0 | 5.6 | 0 | 14 | 4 | 900 | 35% |
| M542 | 6 | 0 | 5.6 | 0 | 14 | 6 | 950 | 37% |
| M543 | 6 | 0 | 5.6 | 0 | 16 | 0 | 850 | 27% |
| M544 | 6 | 0 | 5.6 | 0 | 16 | 2 | 900 | 33% |
| M545 | 6 | 0 | 5.6 | 0 | 16 | 4 | 900 | 37% |
| M546 | 6 | 0 | 5.6 | 0 | 16 | 6 | 900 | 39% |
| M547 | 6 | 0 | 6 | 0 | 8 | 0 | 950 | 20% |
| M548 | 6 | 0 | 6 | 0 | 8 | 2 | 950 | 26% |
| M549 | 6 | 0 | 6 | 0 | 8 | 4 | 950 | 30% |
| M550 | 6 | 0 | 6 | 0 | 10 | 0 | 950 | 22% |
| M551 | 6 | 0 | 6 | 0 | 10 | 2 | 950 | 28% |
| M552 | 6 | 0 | 6 | 0 | 10 | 4 | 950 | 32% |
| M553 | 6 | 0 | 6 | 0 | 12 | 0 | 900 | 24% |
| M554 | 6 | 0 | 6 | 0 | 12 | 2 | 900 | 30% |
| M555 | 6 | 0 | 6 | 0 | 12 | 4 | 950 | 34% |
| M556 | 6 | 0 | 6 | 0 | 12 | 6 | 950 | 36% |
| M557 | 6 | 0 | 6 | 0 | 14 | 0 | 900 | 26% |
| M558 | 6 | 0 | 6 | 0 | 14 | 2 | 900 | 32% |
| M559 | 6 | 0 | 6 | 0 | 14 | 4 | 900 | 36% |
| M560 | 6 | 0 | 6 | 0 | 14 | 6 | 950 | 38% |
| M561 | 6 | 0 | 6 | 0 | 16 | 0 | 850 | 29% |
| M562 | 6 | 0 | 6 | 0 | 16 | 2 | 900 | 34% |
| M563 | 6 | 0 | 6 | 0 | 16 | 4 | 900 | 38% |
| M564 | 6 | 0 | 6 | 0 | 16 | 6 | 900 | 40% |
| M565 | 8 | 0 | 4 | 0 | 8 | 0 | 950 | 17% |
| M566 | 8 | 0 | 4 | 0 | 8 | 2 | 950 | 23% |
| M567 | 8 | 0 | 4 | 0 | 10 | 0 | 950 | 20% |
| M568 | 8 | 0 | 4 | 0 | 10 | 2 | 950 | 25% |
| M569 | 8 | 0 | 4 | 0 | 12 | 0 | 900 | 22% |
| M570 | 8 | 0 | 4 | 0 | 12 | 2 | 950 | 27% |
| M571 | 8 | 0 | 4 | 0 | 12 | 4 | 950 | 30% |
| M572 | 8 | 0 | 4 | 0 | 14 | 0 | 900 | 24% |
| M573 | 8 | 0 | 4 | 0 | 14 | 2 | 900 | 29% |
| M574 | 8 | 0 | 4 | 0 | 14 | 4 | 950 | 32% |
| M575 | 8 | 0 | 4 | 0 | 16 | 0 | 900 | 26% |
| M576 | 8 | 0 | 4 | 0 | 16 | 2 | 900 | 31% |
| M577 | 8 | 0 | 4 | 0 | 16 | 4 | 900 | 34% |
| M578 | 8 | 0 | 4 | 0 | 16 | 6 | 950 | 36% |
| M579 | 8 | 0 | 4.4 | 0 | 8 | 0 | 950 | 19% |
| M580 | 8 | 0 | 4.4 | 0 | 8 | 2 | 950 | 24% |
| M581 | 8 | 0 | 4.4 | 0 | 10 | 0 | 950 | 21% |
| M582 | 8 | 0 | 4.4 | 0 | 10 | 2 | 950 | 26% |
| M583 | 8 | 0 | 4.4 | 0 | 12 | 0 | 900 | 23% |
| M584 | 8 | 0 | 4.4 | 0 | 12 | 2 | 950 | 29% |
| M585 | 8 | 0 | 4.4 | 0 | 12 | 4 | 950 | 31% |
| M586 | 8 | 0 | 4.4 | 0 | 14 | 0 | 900 | 26% |
| M587 | 8 | 0 | 4.4 | 0 | 14 | 2 | 900 | 31% |
| M588 | 8 | 0 | 4.4 | 0 | 14 | 4 | 950 | 33% |
| M589 | 8 | 0 | 4.4 | 0 | 16 | 0 | 900 | 28% |
| M590 | 8 | 0 | 4.4 | 0 | 16 | 2 | 900 | 33% |
| M591 | 8 | 0 | 4.4 | 0 | 16 | 4 | 900 | 35% |
| M592 | 8 | 0 | 4.4 | 0 | 16 | 6 | 950 | 37% |
| M593 | 8 | 0 | 4.8 | 0 | 8 | 0 | 950 | 20% |
| M594 | 8 | 0 | 4.8 | 0 | 8 | 2 | 950 | 26% |
| M595 | 8 | 0 | 4.8 | 0 | 10 | 0 | 950 | 23% |
| M596 | 8 | 0 | 4.8 | 0 | 10 | 2 | 950 | 28% |
| M597 | 8 | 0 | 4.8 | 0 | 12 | 0 | 900 | 25% |
| M598 | 8 | 0 | 4.8 | 0 | 12 | 2 | 950 | 30% |
| M599 | 8 | 0 | 4.8 | 0 | 12 | 4 | 950 | 32% |
| M600 | 8 | 0 | 4.8 | 0 | 14 | 0 | 900 | 27% |
| M601 | 8 | 0 | 4.8 | 0 | 14 | 2 | 900 | 32% |
| M602 | 8 | 0 | 4.8 | 0 | 14 | 4 | 950 | 34% |
| M603 | 8 | 0 | 4.8 | 0 | 16 | 0 | 850 | 29% |
| M604 | 8 | 0 | 4.8 | 0 | 16 | 2 | 900 | 34% |
| M605 | 8 | 0 | 4.8 | 0 | 16 | 4 | 900 | 36% |
| M606 | 8 | 0 | 4.8 | 0 | 16 | 6 | 950 | 38% |
| M607 | 8 | 0 | 5.2 | 0 | 8 | 0 | 950 | 22% |
| M608 | 8 | 0 | 5.2 | 0 | 8 | 2 | 950 | 27% |
| M609 | 8 | 0 | 5.2 | 0 | 10 | 0 | 950 | 24% |
| M610 | 8 | 0 | 5.2 | 0 | 10 | 2 | 950 | 29% |
| M611 | 8 | 0 | 5.2 | 0 | 12 | 0 | 900 | 26% |
| M612 | 8 | 0 | 5.2 | 0 | 12 | 2 | 950 | 31% |
| M613 | 8 | 0 | 5.2 | 0 | 12 | 4 | 950 | 34% |
| M614 | 8 | 0 | 5.2 | 0 | 14 | 0 | 900 | 28% |
| M615 | 8 | 0 | 5.2 | 0 | 14 | 2 | 900 | 33% |
| M616 | 8 | 0 | 5.2 | 0 | 14 | 4 | 950 | 36% |
| M617 | 8 | 0 | 5.2 | 0 | 16 | 0 | 850 | 31% |
| M618 | 8 | 0 | 5.2 | 0 | 16 | 2 | 900 | 35% |
| M619 | 8 | 0 | 5.2 | 0 | 16 | 4 | 900 | 38% |
| M620 | 8 | 0 | 5.2 | 0 | 16 | 6 | 950 | 40% |
| M621 | 8 | 0 | 5.6 | 0 | 8 | 0 | 950 | 23% |
| M622 | 8 | 0 | 5.6 | 0 | 8 | 2 | 950 | 28% |
| M623 | 8 | 0 | 5.6 | 0 | 10 | 0 | 950 | 26% |
| M624 | 8 | 0 | 5.6 | 0 | 10 | 2 | 950 | 30% |
| M625 | 8 | 0 | 5.6 | 0 | 12 | 0 | 900 | 28% |
| M626 | 8 | 0 | 5.6 | 0 | 12 | 2 | 950 | 32% |
| M627 | 8 | 0 | 5.6 | 0 | 12 | 4 | 950 | 35% |
| M628 | 8 | 0 | 5.6 | 0 | 14 | 0 | 900 | 30% |
| M629 | 8 | 0 | 5.6 | 0 | 14 | 2 | 900 | 35% |
| M630 | 8 | 0 | 5.6 | 0 | 14 | 4 | 950 | 37% |
| M631 | 8 | 0 | 5.6 | 0 | 16 | 0 | 850 | 32% |
| M632 | 8 | 0 | 5.6 | 0 | 16 | 2 | 900 | 37% |
| M633 | 8 | 0 | 5.6 | 0 | 16 | 4 | 900 | 39% |
| M634 | 8 | 0 | 5.6 | 0 | 16 | 6 | 950 | 41% |
| M635 | 8 | 0 | 6 | 0 | 8 | 0 | 950 | 25% |
| M636 | 8 | 0 | 6 | 0 | 8 | 2 | 950 | 30% |
| M637 | 8 | 0 | 6 | 0 | 10 | 0 | 950 | 27% |
| M638 | 8 | 0 | 6 | 0 | 10 | 2 | 950 | 32% |
| M639 | 8 | 0 | 6 | 0 | 12 | 0 | 900 | 29% |
| M640 | 8 | 0 | 6 | 0 | 12 | 2 | 900 | 34% |
| M641 | 8 | 0 | 6 | 0 | 12 | 4 | 950 | 36% |
| M642 | 8 | 0 | 6 | 0 | 14 | 0 | 900 | 31% |
| M643 | 8 | 0 | 6 | 0 | 14 | 2 | 900 | 36% |
| M644 | 8 | 0 | 6 | 0 | 14 | 4 | 900 | 38% |
| M645 | 8 | 0 | 6 | 0 | 16 | 0 | 850 | 33% |
| M646 | 8 | 0 | 6 | 0 | 16 | 2 | 900 | 38% |
| M647 | 8 | 0 | 6 | 0 | 16 | 4 | 900 | 40% |
| M648 | 8 | 0 | 6 | 0 | 16 | 6 | 950 | 42% |
| M649 | 10 | 0 | 4 | 0 | 8 | 0 | 950 | 22% |
| M650 | 10 | 0 | 4 | 0 | 10 | 0 | 950 | 24% |
| M651 | 10 | 0 | 4 | 0 | 12 | 0 | 950 | 27% |
| M652 | 10 | 0 | 4 | 0 | 12 | 2 | 950 | 29% |
| M653 | 10 | 0 | 4 | 0 | 14 | 0 | 900 | 29% |
| M654 | 10 | 0 | 4 | 0 | 14 | 2 | 950 | 31% |
| M655 | 10 | 0 | 4 | 0 | 16 | 0 | 900 | 31% |
| M656 | 10 | 0 | 4 | 0 | 16 | 2 | 900 | 34% |
| M657 | 10 | 0 | 4 | 0 | 16 | 4 | 950 | 36% |
| M658 | 10 | 0 | 4.4 | 0 | 8 | 0 | 950 | 24% |
| M659 | 10 | 0 | 4.4 | 0 | 10 | 0 | 950 | 26% |
| M660 | 10 | 0 | 4.4 | 0 | 12 | 0 | 950 | 28% |
| M661 | 10 | 0 | 4.4 | 0 | 12 | 2 | 950 | 31% |
| M662 | 10 | 0 | 4.4 | 0 | 14 | 0 | 900 | 30% |
| M663 | 10 | 0 | 4.4 | 0 | 14 | 2 | 950 | 33% |
| M664 | 10 | 0 | 4.4 | 0 | 16 | 0 | 900 | 32% |
| M665 | 10 | 0 | 4.4 | 0 | 16 | 2 | 900 | 35% |
| M666 | 10 | 0 | 4.4 | 0 | 16 | 4 | 950 | 37% |
| M667 | 10 | 0 | 4.8 | 0 | 8 | 0 | 950 | 25% |
| M668 | 10 | 0 | 4.8 | 0 | 10 | 0 | 950 | 27% |
| M669 | 10 | 0 | 4.8 | 0 | 12 | 0 | 950 | 29% |
| M670 | 10 | 0 | 4.8 | 0 | 12 | 2 | 950 | 32% |
| M671 | 10 | 0 | 4.8 | 0 | 14 | 0 | 900 | 32% |
| M672 | 10 | 0 | 4.8 | 0 | 14 | 2 | 950 | 34% |
| M673 | 10 | 0 | 4.8 | 0 | 16 | 0 | 900 | 34% |
| M674 | 10 | 0 | 4.8 | 0 | 16 | 2 | 900 | 36% |
| M675 | 10 | 0 | 4.8 | 0 | 16 | 4 | 950 | 38% |
| M676 | 10 | 0 | 5.2 | 0 | 8 | 0 | 950 | 26% |
| M677 | 10 | 0 | 5.2 | 0 | 10 | 0 | 950 | 29% |
| M678 | 10 | 0 | 5.2 | 0 | 10 | 2 | 950 | 31% |
| M679 | 10 | 0 | 5.2 | 0 | 12 | 0 | 950 | 31% |
| M680 | 10 | 0 | 5.2 | 0 | 12 | 2 | 950 | 33% |
| M681 | 10 | 0 | 5.2 | 0 | 14 | 0 | 900 | 33% |
| M682 | 10 | 0 | 5.2 | 0 | 14 | 2 | 950 | 35% |
| M683 | 10 | 0 | 5.2 | 0 | 16 | 0 | 900 | 35% |
| M684 | 10 | 0 | 5.2 | 0 | 16 | 2 | 900 | 37% |
| M685 | 10 | 0 | 5.2 | 0 | 16 | 4 | 950 | 39% |
| M686 | 10 | 0 | 5.6 | 0 | 8 | 0 | 950 | 28% |
| M687 | 10 | 0 | 5.6 | 0 | 10 | 0 | 950 | 30% |
| M688 | 10 | 0 | 5.6 | 0 | 10 | 2 | 950 | 32% |
| M689 | 10 | 0 | 5.6 | 0 | 12 | 0 | 950 | 32% |
| M690 | 10 | 0 | 5.6 | 0 | 12 | 2 | 950 | 34% |
| M691 | 10 | 0 | 5.6 | 0 | 14 | 0 | 900 | 34% |
| M692 | 10 | 0 | 5.6 | 0 | 14 | 2 | 950 | 36% |
| M693 | 10 | 0 | 5.6 | 0 | 16 | 0 | 900 | 36% |
| M694 | 10 | 0 | 5.6 | 0 | 16 | 2 | 900 | 38% |
| M695 | 10 | 0 | 5.6 | 0 | 16 | 4 | 950 | 41% |
| M696 | 10 | 0 | 6 | 0 | 8 | 0 | 950 | 29% |
| M697 | 10 | 0 | 6 | 0 | 10 | 0 | 950 | 31% |
| M698 | 10 | 0 | 6 | 0 | 10 | 2 | 950 | 34% |
| M699 | 10 | 0 | 6 | 0 | 12 | 0 | 950 | 33% |
| M700 | 10 | 0 | 6 | 0 | 12 | 2 | 950 | 36% |
| M701 | 10 | 0 | 6 | 0 | 14 | 0 | 900 | 35% |
| M702 | 10 | 0 | 6 | 0 | 14 | 2 | 950 | 38% |
| M703 | 10 | 0 | 6 | 0 | 16 | 0 | 900 | 37% |
| M704 | 10 | 0 | 6 | 0 | 16 | 2 | 900 | 40% |
| M705 | 10 | 0 | 6 | 0 | 16 | 4 | 950 | 42% |
| M706 | 10 | 1 | 0 | 16 | 0 | 0 | 950 | 21% |
| M707 | 10 | 1 | 0 | 16 | 0 | 2 | 950 | 23% |
| M708 | 10 | 1 | 0 | 16 | 0 | 0 | 950 | 21% |
| M709 | 10 | 1 | 0 | 16 | 0 | 2 | 950 | 23% |
| M710 | 10 | 1 | 0 | 16 | 0 | 0 | 950 | 22% |
| M711 | 0 | 1 | 0 | 0 | 16 | 2 | 850 | 22% |
| M712 | 0 | 1 | 0 | 0 | 16 | 4 | 850 | 21% |
| M713 | 0 | 1 | 0 | 0 | 16 | 6 | 900 | 24% |
| M714 | 0 | 1 | 0 | 0 | 16 | 0 | 850 | 24% |
| M715 | 0 | 1 | 0 | 0 | 16 | 2 | 850 | 22% |
| M716 | 0 | 1 | 0 | 0 | 16 | 4 | 850 | 21% |
| M717 | 0 | 1 | 0 | 0 | 16 | 6 | 850 | 24% |
| M718 | 0 | 1 | 0 | 0 | 16 | 0 | 850 | 24% |
| M719 | 0 | 1 | 0 | 0 | 16 | 2 | 850 | 22% |
| M720 | 0 | 1 | 0 | 0 | 16 | 4 | 850 | 21% |
| M721 | 0 | 1 | 0 | 0 | 16 | 6 | 850 | 24% |
| M722 | 0 | 2 | 0 | 0 | 16 | 0 | 850 | 24% |
| M723 | 0 | 2 | 0 | 0 | 16 | 2 | 850 | 23% |
| M724 | 0 | 2 | 0 | 0 | 16 | 4 | 850 | 22% |
| M725 | 0 | 2 | 0 | 0 | 16 | 6 | 850 | 24% |
| M726 | 0 | 2 | 0 | 0 | 16 | 0 | 800 | 24% |
| M727 | 0 | 2 | 0 | 0 | 16 | 2 | 850 | 23% |
| M728 | 0 | 2 | 0 | 0 | 16 | 4 | 850 | 22% |
| M729 | 0 | 2 | 0 | 0 | 16 | 6 | 850 | 24% |
| M730 | 0 | 2 | 0 | 0 | 16 | 0 | 800 | 25% |
| M731 | 0 | 2 | 0 | 0 | 16 | 2 | 800 | 23% |
| M732 | 0 | 2 | 0 | 0 | 16 | 4 | 850 | 22% |
| M733 | 0 | 2 | 0 | 0 | 16 | 6 | 850 | 24% |
| M734 | 0 | 2 | 0 | 0 | 16 | 0 | 800 | 25% |
| M735 | 0 | 2 | 0 | 0 | 16 | 2 | 800 | 23% |
| M736 | 0 | 2 | 0 | 0 | 16 | 4 | 800 | 22% |
| M737 | 0 | 2 | 0 | 0 | 16 | 6 | 850 | 25% |
| M738 | 0 | 2 | 0 | 0 | 16 | 0 | 800 | 25% |
| M739 | 0 | 2 | 0 | 0 | 16 | 2 | 800 | 23% |
| M740 | 0 | 2 | 0 | 0 | 16 | 4 | 800 | 22% |
| M741 | 0 | 2 | 0 | 0 | 16 | 6 | 850 | 25% |
| M742 | 0 | 3 | 0 | 0 | 16 | 0 | 800 | 25% |
| M743 | 0 | 3 | 0 | 0 | 16 | 2 | 800 | 24% |
| M744 | 0 | 3 | 0 | 0 | 16 | 4 | 800 | 23% |
| M745 | 0 | 3 | 0 | 0 | 16 | 6 | 800 | 25% |
| M746 | 0 | 3 | 0 | 0 | 16 | 0 | 750 | 26% |
| M747 | 0 | 3 | 0 | 0 | 16 | 2 | 800 | 24% |
| M748 | 0 | 3 | 0 | 0 | 16 | 4 | 800 | 23% |
| M749 | 0 | 3 | 0 | 0 | 16 | 6 | 800 | 25% |
| M750 | 0 | 3 | 0 | 0 | 16 | 0 | 750 | 26% |
| M751 | 0 | 3 | 0 | 0 | 16 | 2 | 750 | 24% |
| M752 | 0 | 3 | 0 | 0 | 16 | 4 | 800 | 23% |
| M753 | 0 | 3 | 0 | 0 | 16 | 6 | 800 | 25% |
| M754 | 2 | 1 | 0 | 0 | 16 | 0 | 850 | 22% |
| M755 | 2 | 1 | 0 | 0 | 16 | 2 | 850 | 21% |
| M756 | 2 | 1 | 0 | 0 | 16 | 4 | 850 | 23% |
| M757 | 2 | 1 | 0 | 0 | 16 | 6 | 900 | 18% |
| M758 | 2 | 1 | 0 | 0 | 16 | 0 | 850 | 23% |
| M759 | 2 | 1 | 0 | 0 | 16 | 2 | 850 | 21% |
| M760 | 2 | 1 | 0 | 0 | 16 | 4 | 850 | 23% |
| M761 | 2 | 1 | 0 | 0 | 16 | 6 | 900 | 19% |
| M762 | 2 | 1 | 0 | 0 | 16 | 0 | 850 | 23% |
| M763 | 2 | 1 | 0 | 0 | 16 | 2 | 850 | 21% |
| M764 | 2 | 1 | 0 | 0 | 16 | 4 | 850 | 23% |
| M765 | 2 | 1 | 0 | 0 | 16 | 6 | 900 | 19% |
| M766 | 2 | 2 | 0 | 0 | 16 | 0 | 850 | 23% |
| M767 | 2 | 2 | 0 | 0 | 16 | 2 | 850 | 22% |
| M768 | 2 | 2 | 0 | 0 | 16 | 4 | 850 | 23% |
| M769 | 2 | 2 | 0 | 0 | 16 | 6 | 850 | 19% |
| M770 | 2 | 2 | 0 | 0 | 16 | 0 | 850 | 23% |
| M771 | 2 | 2 | 0 | 0 | 16 | 2 | 850 | 22% |
| M772 | 2 | 2 | 0 | 0 | 16 | 4 | 850 | 23% |
| M773 | 2 | 2 | 0 | 0 | 16 | 6 | 850 | 19% |
| M774 | 2 | 2 | 0 | 0 | 16 | 0 | 800 | 23% |
| M775 | 2 | 2 | 0 | 0 | 16 | 2 | 850 | 22% |
| M776 | 2 | 2 | 0 | 0 | 16 | 4 | 850 | 23% |
| M777 | 2 | 2 | 0 | 0 | 16 | 6 | 850 | 19% |
| M778 | 2 | 2 | 0 | 0 | 16 | 0 | 800 | 24% |
| M779 | 2 | 2 | 0 | 0 | 16 | 2 | 800 | 22% |
| M780 | 2 | 2 | 0 | 0 | 16 | 4 | 850 | 24% |
| M781 | 2 | 2 | 0 | 0 | 16 | 6 | 850 | 20% |
| M782 | 2 | 2 | 0 | 0 | 16 | 0 | 800 | 24% |
| M783 | 2 | 2 | 0 | 0 | 16 | 2 | 800 | 22% |
| M784 | 2 | 2 | 0 | 0 | 16 | 4 | 850 | 24% |
| M785 | 2 | 2 | 0 | 0 | 16 | 6 | 850 | 20% |
| M786 | 2 | 3 | 0 | 0 | 16 | 0 | 800 | 24% |
| M787 | 2 | 3 | 0 | 0 | 16 | 2 | 800 | 23% |
| M788 | 2 | 3 | 0 | 0 | 16 | 4 | 800 | 24% |
| M789 | 2 | 3 | 0 | 0 | 16 | 6 | 850 | 20% |
| M790 | 2 | 3 | 0 | 0 | 16 | 0 | 800 | 24% |
| M791 | 2 | 3 | 0 | 0 | 16 | 2 | 800 | 23% |
| M792 | 2 | 3 | 0 | 0 | 16 | 4 | 800 | 24% |
| M793 | 2 | 3 | 0 | 0 | 16 | 6 | 850 | 20% |
| M794 | 2 | 3 | 0 | 0 | 16 | 0 | 750 | 24% |
| M795 | 2 | 3 | 0 | 0 | 16 | 2 | 800 | 23% |
| M796 | 2 | 3 | 0 | 0 | 16 | 4 | 800 | 24% |
| M797 | 2 | 3 | 0 | 0 | 16 | 6 | 800 | 20% |
| M798 | 4 | 1 | 0 | 0 | 16 | 0 | 850 | 21% |
| M799 | 4 | 1 | 0 | 0 | 16 | 2 | 850 | 21% |
| M800 | 4 | 1 | 0 | 0 | 16 | 4 | 900 | 19% |
| M801 | 4 | 1 | 0 | 0 | 16 | 6 | 900 | 20% |
| M802 | 4 | 1 | 0 | 0 | 16 | 0 | 850 | 21% |
| M803 | 4 | 1 | 0 | 0 | 16 | 2 | 850 | 21% |
| M804 | 4 | 1 | 0 | 0 | 16 | 4 | 900 | 19% |
| M805 | 4 | 1 | 0 | 0 | 16 | 6 | 900 | 20% |
| M806 | 4 | 1 | 0 | 0 | 16 | 0 | 850 | 22% |
| M807 | 4 | 1 | 0 | 0 | 16 | 2 | 850 | 21% |
| M808 | 4 | 1 | 0 | 0 | 16 | 4 | 850 | 19% |
| M809 | 4 | 1 | 0 | 0 | 16 | 6 | 900 | 20% |
| M810 | 4 | 2 | 0 | 0 | 16 | 0 | 850 | 22% |
| M811 | 4 | 2 | 0 | 0 | 16 | 2 | 850 | 21% |
| M812 | 4 | 2 | 0 | 0 | 16 | 4 | 850 | 19% |
| M813 | 4 | 2 | 0 | 0 | 16 | 6 | 900 | 20% |
| M814 | 4 | 2 | 0 | 0 | 16 | 0 | 850 | 22% |
| M815 | 4 | 2 | 0 | 0 | 16 | 2 | 850 | 22% |
| M816 | 4 | 2 | 0 | 0 | 16 | 4 | 850 | 19% |
| M817 | 4 | 2 | 0 | 0 | 16 | 6 | 850 | 21% |
| M818 | 4 | 2 | 0 | 0 | 16 | 0 | 850 | 22% |
| M819 | 4 | 2 | 0 | 0 | 16 | 2 | 850 | 22% |
| M820 | 4 | 2 | 0 | 0 | 16 | 4 | 850 | 20% |
| M821 | 4 | 2 | 0 | 0 | 16 | 6 | 850 | 21% |
| M822 | 4 | 2 | 0 | 0 | 16 | 0 | 800 | 22% |
| M823 | 4 | 2 | 0 | 0 | 16 | 2 | 850 | 22% |
| M824 | 4 | 2 | 0 | 0 | 16 | 4 | 850 | 20% |
| M825 | 4 | 2 | 0 | 0 | 16 | 6 | 850 | 21% |
| M826 | 4 | 2 | 0 | 0 | 16 | 0 | 800 | 23% |
| M827 | 4 | 2 | 0 | 0 | 16 | 2 | 800 | 22% |
| M828 | 4 | 2 | 0 | 0 | 16 | 4 | 850 | 20% |
| M829 | 4 | 2 | 0 | 0 | 16 | 6 | 850 | 21% |
| M830 | 4 | 3 | 0 | 0 | 16 | 0 | 800 | 23% |
| M831 | 4 | 3 | 0 | 0 | 16 | 2 | 800 | 22% |
| M832 | 4 | 3 | 0 | 0 | 16 | 4 | 850 | 20% |
| M833 | 4 | 3 | 0 | 0 | 16 | 6 | 850 | 21% |
| M834 | 4 | 3 | 0 | 0 | 16 | 0 | 800 | 23% |
| M835 | 4 | 3 | 0 | 0 | 16 | 2 | 800 | 23% |
| M836 | 4 | 3 | 0 | 0 | 16 | 4 | 850 | 20% |
| M837 | 4 | 3 | 0 | 0 | 16 | 6 | 850 | 22% |
| M838 | 4 | 3 | 0 | 0 | 16 | 0 | 800 | 23% |
| M839 | 4 | 3 | 0 | 0 | 16 | 2 | 800 | 23% |
| M840 | 4 | 3 | 0 | 0 | 16 | 4 | 800 | 21% |
| M841 | 4 | 3 | 0 | 0 | 16 | 6 | 850 | 22% |
| M842 | 6 | 1 | 0 | 0 | 16 | 0 | 850 | 20% |
| M843 | 6 | 1 | 0 | 0 | 16 | 2 | 900 | 19% |
| M844 | 6 | 1 | 0 | 0 | 16 | 4 | 900 | 20% |
| M845 | 6 | 1 | 0 | 0 | 16 | 6 | 900 | 22% |
| M846 | 6 | 1 | 0 | 0 | 16 | 0 | 850 | 20% |
| M847 | 6 | 1 | 0 | 0 | 16 | 2 | 850 | 19% |
| M848 | 6 | 1 | 0 | 0 | 16 | 4 | 900 | 20% |
| M849 | 6 | 1 | 0 | 0 | 16 | 6 | 900 | 22% |
| M850 | 6 | 1 | 0 | 0 | 16 | 0 | 850 | 21% |
| M851 | 6 | 1 | 0 | 0 | 16 | 2 | 850 | 19% |
| M852 | 6 | 1 | 0 | 0 | 16 | 4 | 900 | 20% |
| M853 | 6 | 1 | 0 | 0 | 16 | 6 | 900 | 22% |
| M854 | 6 | 2 | 0 | 0 | 16 | 0 | 850 | 21% |
| M855 | 6 | 2 | 0 | 0 | 16 | 2 | 850 | 20% |
| M856 | 6 | 2 | 0 | 0 | 16 | 4 | 900 | 20% |
| M857 | 6 | 2 | 0 | 0 | 16 | 6 | 900 | 22% |
| M858 | 6 | 2 | 0 | 0 | 16 | 0 | 850 | 21% |
| M859 | 6 | 2 | 0 | 0 | 16 | 2 | 850 | 20% |
| M860 | 6 | 2 | 0 | 0 | 16 | 4 | 850 | 20% |
| M861 | 6 | 2 | 0 | 0 | 16 | 6 | 900 | 22% |
| M862 | 6 | 2 | 0 | 0 | 16 | 0 | 850 | 21% |
| M863 | 6 | 2 | 0 | 0 | 16 | 2 | 850 | 20% |
| M864 | 6 | 2 | 0 | 0 | 16 | 4 | 850 | 20% |
| M865 | 6 | 2 | 0 | 0 | 16 | 6 | 900 | 23% |
| M866 | 6 | 2 | 0 | 0 | 16 | 0 | 850 | 21% |
| M867 | 6 | 2 | 0 | 0 | 16 | 2 | 850 | 20% |
| M868 | 6 | 2 | 0 | 0 | 16 | 4 | 850 | 21% |
| M869 | 6 | 2 | 0 | 0 | 16 | 6 | 900 | 23% |
| M870 | 6 | 2 | 0 | 0 | 16 | 0 | 800 | 22% |
| M871 | 6 | 2 | 0 | 0 | 16 | 2 | 850 | 20% |
| M872 | 6 | 2 | 0 | 0 | 16 | 4 | 850 | 21% |
| M873 | 6 | 2 | 0 | 0 | 16 | 6 | 850 | 23% |
| M874 | 6 | 3 | 0 | 0 | 16 | 0 | 800 | 22% |
| M875 | 6 | 3 | 0 | 0 | 16 | 2 | 850 | 21% |
| M876 | 6 | 3 | 0 | 0 | 16 | 4 | 850 | 21% |
| M877 | 6 | 3 | 0 | 0 | 16 | 6 | 850 | 23% |
| M878 | 6 | 3 | 0 | 0 | 16 | 0 | 800 | 22% |
| M879 | 6 | 3 | 0 | 0 | 16 | 2 | 800 | 21% |
| M880 | 6 | 3 | 0 | 0 | 16 | 4 | 850 | 21% |
| M881 | 6 | 3 | 0 | 0 | 16 | 6 | 850 | 23% |
| M882 | 6 | 3 | 0 | 0 | 16 | 0 | 800 | 22% |
| M883 | 6 | 3 | 0 | 0 | 16 | 2 | 800 | 21% |
| M884 | 6 | 3 | 0 | 0 | 16 | 4 | 850 | 21% |
| M885 | 6 | 3 | 0 | 0 | 16 | 6 | 850 | 23% |
| M886 | 8 | 1 | 0 | 0 | 16 | 0 | 850 | 19% |
| M887 | 8 | 1 | 0 | 0 | 16 | 2 | 900 | 19% |
| M888 | 8 | 1 | 0 | 0 | 16 | 4 | 900 | 21% |
| M889 | 8 | 1 | 0 | 0 | 16 | 0 | 850 | 20% |
| M890 | 8 | 1 | 0 | 0 | 16 | 2 | 900 | 19% |
| M891 | 8 | 1 | 0 | 0 | 16 | 4 | 900 | 22% |
| M892 | 8 | 1 | 0 | 0 | 16 | 0 | 850 | 20% |
| M893 | 8 | 1 | 0 | 0 | 16 | 2 | 900 | 20% |
| M894 | 8 | 1 | 0 | 0 | 16 | 4 | 900 | 22% |
| M895 | 8 | 2 | 0 | 0 | 16 | 0 | 850 | 20% |
| M896 | 8 | 2 | 0 | 0 | 16 | 2 | 900 | 20% |
| M897 | 8 | 2 | 0 | 0 | 16 | 4 | 900 | 22% |
| M898 | 8 | 2 | 0 | 0 | 16 | 0 | 850 | 20% |
| M899 | 8 | 2 | 0 | 0 | 16 | 2 | 850 | 20% |
| M900 | 8 | 2 | 0 | 0 | 16 | 4 | 900 | 22% |
| M901 | 8 | 2 | 0 | 0 | 16 | 0 | 850 | 20% |
| M902 | 8 | 2 | 0 | 0 | 16 | 2 | 850 | 20% |
| M903 | 8 | 2 | 0 | 0 | 16 | 4 | 850 | 22% |
| M904 | 8 | 2 | 0 | 0 | 16 | 0 | 850 | 21% |
| M905 | 8 | 2 | 0 | 0 | 16 | 2 | 850 | 20% |
| M906 | 8 | 2 | 0 | 0 | 16 | 4 | 850 | 22% |
| M907 | 8 | 2 | 0 | 0 | 16 | 0 | 850 | 21% |
| M908 | 8 | 2 | 0 | 0 | 16 | 2 | 850 | 20% |
| M909 | 8 | 2 | 0 | 0 | 16 | 4 | 850 | 23% |
| M910 | 8 | 3 | 0 | 0 | 16 | 0 | 800 | 21% |
| M911 | 8 | 3 | 0 | 0 | 16 | 2 | 850 | 21% |
| M912 | 8 | 3 | 0 | 0 | 16 | 4 | 850 | 23% |
| M913 | 8 | 3 | 0 | 0 | 16 | 0 | 800 | 21% |
| M914 | 8 | 3 | 0 | 0 | 16 | 2 | 850 | 21% |
| M915 | 8 | 3 | 0 | 0 | 16 | 4 | 850 | 23% |
| M916 | 8 | 3 | 0 | 0 | 16 | 0 | 800 | 21% |
| M917 | 8 | 3 | 0 | 0 | 16 | 2 | 850 | 21% |
| M918 | 8 | 3 | 0 | 0 | 16 | 4 | 850 | 23% |
| M919 | 10 | 1 | 0 | 0 | 16 | 0 | 900 | 19% |
| M920 | 10 | 1 | 0 | 0 | 16 | 2 | 900 | 21% |
| M921 | 10 | 1 | 0 | 0 | 16 | 4 | 950 | 23% |
| M922 | 10 | 1 | 0 | 0 | 16 | 0 | 900 | 19% |
| M923 | 10 | 1 | 0 | 0 | 16 | 2 | 900 | 21% |
| M924 | 10 | 1 | 0 | 0 | 16 | 4 | 950 | 23% |
| M925 | 10 | 1 | 0 | 0 | 16 | 0 | 900 | 19% |
| M926 | 10 | 1 | 0 | 0 | 16 | 2 | 900 | 21% |
| M927 | 10 | 1 | 0 | 0 | 16 | 4 | 950 | 24% |
| M928 | 10 | 2 | 0 | 0 | 16 | 0 | 900 | 19% |
| M929 | 10 | 2 | 0 | 0 | 16 | 2 | 900 | 22% |
| M930 | 10 | 2 | 0 | 0 | 16 | 4 | 950 | 24% |
| M931 | 10 | 2 | 0 | 0 | 16 | 0 | 850 | 20% |
| M932 | 10 | 2 | 0 | 0 | 16 | 2 | 900 | 22% |
| M933 | 10 | 2 | 0 | 0 | 16 | 4 | 950 | 24% |
| M934 | 10 | 2 | 0 | 0 | 16 | 0 | 850 | 20% |
| M935 | 10 | 2 | 0 | 0 | 16 | 2 | 850 | 22% |
| M936 | 10 | 2 | 0 | 0 | 16 | 4 | 950 | 24% |
| M937 | 10 | 2 | 0 | 0 | 16 | 0 | 850 | 20% |
| M938 | 10 | 2 | 0 | 0 | 16 | 2 | 850 | 22% |
| M939 | 10 | 2 | 0 | 0 | 16 | 4 | 950 | 24% |
| M940 | 10 | 2 | 0 | 0 | 16 | 0 | 850 | 20% |
| M941 | 10 | 2 | 0 | 0 | 16 | 2 | 850 | 22% |
| M942 | 10 | 2 | 0 | 0 | 16 | 4 | 950 | 24% |
| M943 | 10 | 3 | 0 | 0 | 16 | 0 | 850 | 20% |
| M944 | 10 | 3 | 0 | 0 | 16 | 2 | 850 | 22% |
| M945 | 10 | 3 | 0 | 0 | 16 | 0 | 850 | 21% |
| M946 | 10 | 3 | 0 | 0 | 16 | 2 | 850 | 23% |
| M947 | 10 | 3 | 0 | 0 | 16 | 0 | 850 | 21% |
| M948 | 10 | 3 | 0 | 0 | 16 | 2 | 850 | 23% |
| M949 | 0 | 1 | 0 | 0 | 16 | 0 | 850 | 23% |

The disclosed alloys can incorporate the above elemental constituents to a total of 100 wt. %. In some embodiments, the alloy may include, may be limited to, or may consist essentially of the above named elements. In some embodiments, the alloy may include 2% or less of impurities. Impurities may be understood as elements or compositions that may be included in the alloys due to inclusion in the feedstock components, through introduction in the manufacturing process.

Further, the Fe content identified in all of the compositions described in the above paragraphs may be the balance of the composition as indicated above, or alternatively, the balance of the composition may comprise Fe and other elements. In some embodiments, the balance may consist essentially of Fe and may include incidental impurities. In some embodiments, the compositions can have at least 60 wt. % Fe (or at least about 60 wt. % Fe). In some embodiments, the composition can have between 60 and 80 wt. % Fe (or between about 60 and about 80 wt. % Fe).

### Thermodynamic Criteria

In some embodiments, the alloys can be fully described by thermodynamic criteria. Alloys which meet all the disclosed thermodynamic criteria have a high likelihood of exhibiting both the desired microstructural features and performance characteristics disclosed herein.

In some embodiments, oxidation of elements during the thermal spray process, specifically the twin wire arc spray process, can affect the composition of the alloy and can make modelling inaccurate. Thus, the alloy can be modelled with a specified oxygen addition in order to predict the behavior of the alloy during the twin wire arc spray process. It has been determined through extensive experimentation, that 8 wt. % oxygen can be added to the alloy model in order to best predict the behavior of the twin wire arc spray process. This is further justified in example 1, discussed below. Oxygen is added to the model such that the relative ratio between elements in the computed alloy remains constant.

The oxygen addition to the model is used to account for the oxidation of certain elemental species during the thermal spray process. The oxidation reaction is not similar between all elements in the alloy, and certain elements will preferentially oxidize. This oxidation behavior is a key component in the understanding and design of thermal spray alloys.

The oxidation model described herein describes the process by which the feedstock alloy is transformed into the coating alloy. In the twin wire arc spray process, the feedstock alloy is in the form of two wires and contains a certain feedstock chemistry. During the twin wire arc spray process, these two wires are heated to above their melting temperature and sprayed through the air. During this step, the feedstock alloy will react with oxygen in the environment. The result of this oxidation reaction is the deposition of a coating chemistry onto the substrate which is different from the feedstock chemistry.

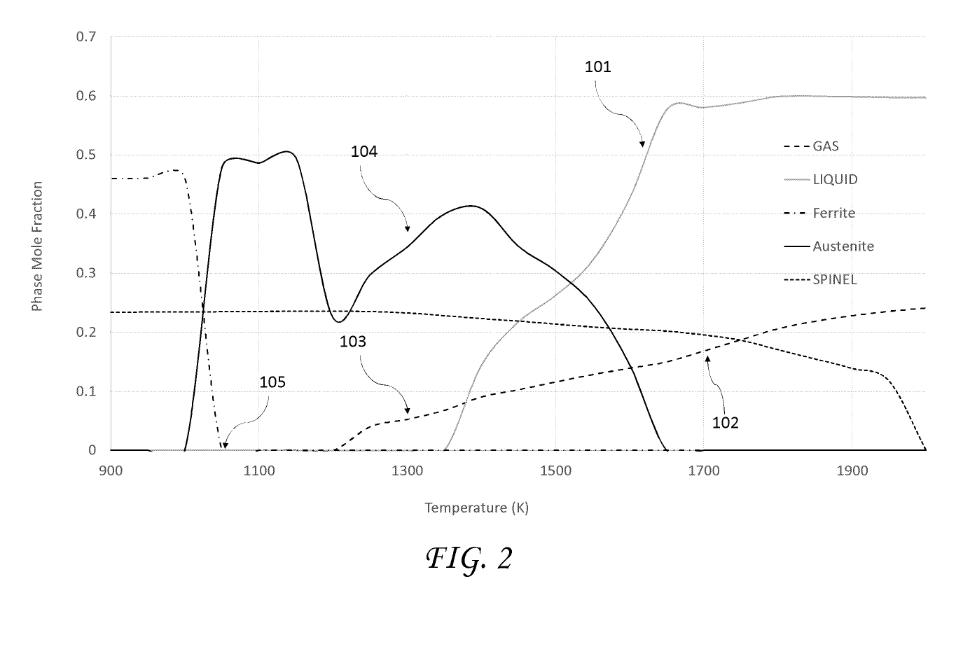

The thermodynamic solidification model for Alloy X3 with 8% O added is shown in FIG. 2. This solidification diagram simulates the process by which a feedstock chemistry is melted, atomized, reacts with oxygen in the air, contacts the substrate, and finally cools to room temperature. Many oxides and secondary phases are present in this thermodynamic diagram so for clarity only specific phases are shown. As shown in FIG. 2, at extremely high temperatures, above 1900K, the alloy is composed of both a Fe-based liquid [101] and carbon dioxide gas [102]. Immediately, the effect of oxidation can be seen as carbon is oxidized and thereby removed from the feedstock composition. At 1900K the spinel oxide [103] begins to form which is a Cr, Mn, Al bearing oxide. Again, this oxidation effect will remove Al, Cr, and Mn from the feedstock chemistry and affect the coating chemistry and performance. At about 1600K, the austenite forms [104]. The austenite phase, depending on the alloy composition, may transition into ferrite [105] at a lower temperature.

FIG. 2 can thereby be used to separate the coating chemistry from the feedstock chemistry. As mentioned, FIG. 2 shows the preferential oxidation of certain elemental species into oxides such as carbon in CO₂ gas and Al, Mn, and Cr into a spinel. As these elements are oxidized, they are removed from the feedstock chemistry and no longer contribute to the microstructure of the coating chemistry itself.

The coating chemistry dictates the actual performance of the coating. In some embodiments, the coating chemistry is used to predict the FCC-BCC transition temperature (T_{γ to α}) and the solid solution strengthening behavior. If the feedstock chemistry is used to predict the T_{γ to α} and the solid solution strengthening behavior, then the predictions will be inaccurate. This inaccuracy can be demonstrated with the addition of Mn to an alloy. Mn is known to promote the formation of austenite. However, Mn is also known to oxidize very rapidly in air. Thus, a feedstock alloy containing Mn has some or all of the Mn oxidized during the thermal spray process. In this example, the coating alloy will no longer meet the thermodynamic criteria of this patent. This effect will specifically be shown in additional examples.

The first thermodynamic criteria is related to the FCC-BCC transition in the alloy. This transition temperature marks the transition of the steel matrix from an austenitic structure (FCC) to a ferritic structure (BCC). The FCC-BCC transition temperature will be hereby abbreviated by the symbol, T_{γ to α}. T_{γ to α} acts as a predictor for the final matrix chemistry of the matrix phase. Alloys with relatively low T_{γ to α} will likely possessing form an austenitic matrix in the thermal sprayed coating form.

In some embodiments, the T_{γ to α} can be at or below 950K (or at or below about 950K). In some embodiments, the T_{γ to α} can be at or below 900K (or at or below about 900K). In some embodiments, the T_{γ to α} can be at or below 850K (or at or below about 850K).

Another thermodynamic embodiment is related to the solid solution strengthening of the matrix phase. Solid solution strengthening occurs when dissimilar elements are added to the iron matrix. Elements which are added to the alloy chemistry, but which do not form secondary phases contribute to solid solution strengthening. In this embodiment, the solid solution strengthening of austenite is considered. As the total concentration of solute elements are added to the alloy increases, the solid solution strengthening effect increases. Some elements known to cause solid solution strengthening include boron, carbon, nitrogen, chromium, molybdenum, tungsten, nickel. In addition a broad spectrum of elements can contribute to the solid solution strengthening of austenitic steels including calcium, titanium, manganese, copper, zinc, yttrium, niobium, and tin. In some embodiments, all elements outside of Fe can be considered solid solution strengthening. Accordingly, embodiments of the alloy can contain between 10 and 30 wt. % (or between about 10 and about 30 wt. %) total solute element content. In some embodiments, the alloy can contain at least 5 wt. % (or at least about 5 wt. %) elemental solute in the final matrix. In some embodiments, the alloy can contain at least 10 wt. % (or at least about 10 wt. %) elemental solute in the final matrix. In some embodiments, the alloy can contain at least 15 wt. % (or at least about 15 wt. %) elemental solute in the final matrix.

These thermodynamic criteria are related and can simultaneously be considered to design an effective alloy under this disclosure. As mentioned, Mn is an austenite stabilizer, can contribute to solid solution strengthening, but is also prone to rapid oxidation. Navigating these related criteria for complex alloy systems of three or more elements requires the use of advanced computational metallurgy. As another example, aluminum and/or silicon can be added to the feedstock alloy to preferentially oxidize and protect other elements from oxidation. However, Al and Si will tend to stabilize ferrite resulting in a coating which will not be readable. Almost every alloying element is an austenite or ferrite stabilizer, can contribute in some way to solid solution strengthening, and has stronger or weaker oxidation thermodynamics in relation to the other alloying elements. Thus, the type of alloying element and the relative ratios between them must be precisely controlled within narrow compositional ranges in order to meet the embodiments of this disclosure.

### Microstructural Criteria

In some embodiments, the alloy can be fully described by microstructural characteristics. The microstructural features of the alloy are relevant in the coating form, after spray has been completed, as opposed to the structure of the feedstock wire.

One microstructural criteria is the presence of austenite in the coating. Austenite is the non-magnetic form of iron, and the coating microstructure must be primarily austenite in order for the coating to be nonmagnetic and furthermore readable.

In some embodiments, the austenite can make up 50% (or about 50%) or more of the volume fraction of the coating. In some embodiments, the austenite can make up 90% (or about 90%) or more of the volume fraction of the coating. In some embodiments, the austenite can make up 99% (or about 99%) or more of the volume fraction of the coating. In some embodiments, the austenite can make up 100% (or about 100%) of the volume fraction of the coating. Generally, a thermal spray coating is composed of many different splats of different composition. Having high austenite levels can be achieved by ensuring even the splat with the poorest composition for austenite formation is of a composition which forms austenite such that the average coating chemistry is well into the austenite forming region. Austenite formation can be controlled by the all the elements in concert, so it's a multi-dimensional system.

Another microstructural criteria is the microhardness of the coating. The microhardness of the alloy is dependent on the solid solution strengthening and increases the wear resistance of the material.

In some embodiments, the microhardness of the alloy coating can be 400 HV or above (or about 400 HV or above). In some embodiments, the microhardness of the alloy coating can be 450 HV or above (or about 450 HV or above). In some embodiments, the microhardness of the alloy coating can be 500 HV or above (or about 500 HV or above).

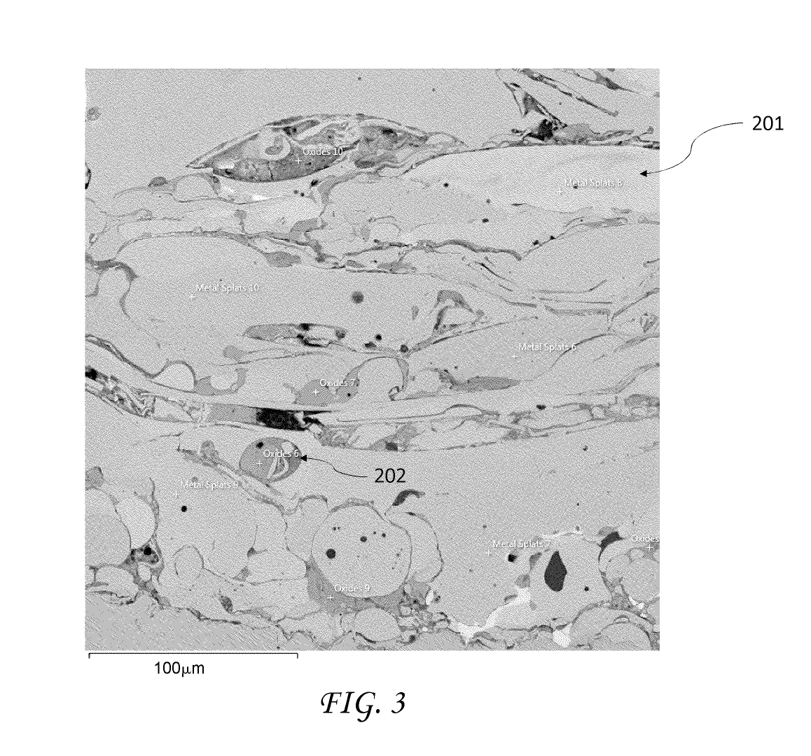

A scanning electron micrograph of X3 is shown in FIG. 3. This micrograph represents a typical embodiment of this disclosure, whereby Fe-based austenite splats [201] and embedded oxides [202] are built up to form the coating structure.

### Performance Criteria

In some embodiments, the alloy can be fully described by a set of performance characteristics. These performance characteristics can be relevant to the alloy coating after deposition, as opposed to the feedstock of the alloy prior to thermal spray processing.

One performance criteria is related to the readability of the coating. Readability is a trait by which the coating thickness can be measured using a paint thickness gauge, such as an Elcometer 456 or similar, which determines magnetic readings. Most iron based thermal spray coatings are magnetic due to the significant portion of either ferrite or martensite in the coating. Embodiments of the disclosure disclose alloys which are non-magnetic and can be thus read with standard paint thickness gauge equipment (e.g., dry film thickness gauge or coating thickness gauge).

Specifically, readability can be measured by measuring a sprayed thermal spray coupon via a standard 0-1 micrometer (providing the “true” measurement of the thickness) and an Elcometer 456 gauge (providing the magnetic measurement of the thickness) in similar locations on the coating. If the thickness measurements are comparable between both techniques, the coating is readable. If the thickness measurements are not comparable, or there is a large degree of scatter in the magnetic coating thickness measurements, the coating is not readable.

In some embodiments, the magnetic thickness measurement can be within 20% (or about 20%) of the micrometer measurement. In some embodiments, the magnetic thickness measurement can be within 15% (or about 15%) of the micrometer measurement. In some embodiments, the magnetic thickness measurement can be within 10% (or about 10%) of the micrometer measurement.

In some embodiments, thermal spray operators can measure readability by measuring one spot with the Elcometer many times. The Elcometer will always register a reading of measurement but a magnetic coating will cause the measurement readings to vary wildly. A readable coating may also show a different measurement readings with each measurement, but will be a standard deviation around the actual physical thickness. In some embodiments, the magnetic thickness gauge can have a 25% (or about 25%) standard deviation in measurements. In some embodiments, the magnetic thickness gauge can have a 20% (or about 20%) standard deviation in measurements. some embodiments, the magnetic thickness gauge can have a 15% (or about 15%) standard deviation in measurements.

Another performance characteristic is the wear resistance of the material. There are two wear measurement test relevant to this disclosure, ASTM G65 Procedure B and hot erosion testing under ASTM G76, the entirety of both of which are hereby incorporated by reference. Both techniques are relevant to a common application of thermal spray coatings, the protection of boiler tubes in power generation equipment.

In some embodiments, the ASTM G65B mass loss of the coating can be 0.75 grams or less (or about 0.75 grams or less). In some embodiments, the ASTM G65B mass loss of the coating can be 0.6 grams or less (or about 0.6 grams or less). In some embodiments, the ASTM G65B mass loss of the coating can be 0.5 grams or less (or about 0.5 grams or less).

In some embodiments, the coating can be measured for mass loss under hot erosion testing using 30° (or about 30°) impingement angle, 600° C. (or about 600° C.) operation temperature, and Ottawa 50/70 silica sand. In some embodiments, the alloy can lose less than 400 mg (or less than about 400 mg) in hot erosion testing. In some embodiments, the alloy can lose less than 300 mg (or less than about 300 mg) in hot erosion testing. In some embodiments, the alloy can lose less than 200 mg (or less than about 200 mg) in hot erosion testing.

Another performance criterion is related to the adhesion of the coating. Adhesion of a thermal spray coating can be measured via ASTM 4541 or ASTM C633, the entirety of each of which is incorporated by reference in its entirety. It can be advantageous for the coating to have a high adhesion in order to prevent spalling or other premature failure of the coating during service or application.

In some embodiments, the adhesion strength can be 5,000 psi (or about 5,000 psi) or higher. In some embodiments, the adhesion strength can be 6,000 psi (or about 5,000 psi) or higher. In some embodiments, the adhesion strength can be 7,000 psi (or about 7,000 psi) or higher. These values apply to both the ASTM 4541 and ASTM C633 tests.

### EXAMPLES

The following examples are intended to be illustrative and non-limiting.

### Example 1

In order to quantify the effect of oxidation on the difference between feedstock chemistry and coating chemistry of coating produced via the twin wire arc spray process, extensive experimentation was conducted. The purpose of this experimentation was to determine an oxygen content to be used in the modelling of future alloys found within this disclosure. Three alloys where sprayed in this example via the twin wire arc spray process, as listed according to feedstock chemistry below in Table 3. Alloys E1-E3, which are known and non-readable thermal spray alloys, were sprayed in addition to the X3 alloy described above.

TABLE 3
List of feedstock chemistries provided in Example
1, meets the thermodynamic, micro structural, and
performance embodiments of this disclosure.

| Alloy | Al | Cr | Mn | Mo | Nb | Si | Ti | V | W |
|---|---|---|---|---|---|---|---|---|---|
| E1 | 2 | 0 | 5 | 13 | 0 | 10 | 0 | 0 | 0 |
| E2 | 0 | 26.5 | 1.6 | 0 | 0 | 1.6 | 0 | 0 | 0 |
| E3 | 1.92 | 12.5 | 1 | 0 | 5.75 | 1 | 0 | 0 | 0 |

The three alloys present in Table 3 represent the feedstock chemistry of the wires prior to being subject to the twin wire arc spray process. In each case, the alloy was subject to the twin wire arc spray process under similar spray parameters and deposited onto a separate steel coupon corresponding to each alloy. The coating chemistry of each alloy was measured via energy dispersive spectroscopy in a scanning electron microscope. The results of the coating chemistries for each alloy is shown in Table 4. As evident, the feedstock chemistry is not equivalent to the resultant coating chemistry. For example, the Mn content is significantly reduced when used in the feedstock chemistry at levels above 2 wt. %.

TABLE 4
Coating chemistry of alloys evaluated in Example 1.

| Alloy | Al | Cr | Mn | Mo | Nb | Si | Ti | V | W |
|---|---|---|---|---|---|---|---|---|---|
| X3 | 1.8 | 5.9 | 8.2 | 0 | 4.5 | 0 | 0.34 | 0.85 | 5.3 |
| E1 | 1.7 | 0 | 2.5 | 15 | 0 | 9.25 | 0 | 0 | 0 |
| E2 | 0 | 29.5 | 1.06 | 0 | 0 | 1.3 | 0 | 0 | 0 |
| E3 | 1.04 | 14.3 | 1.05 | 0 | 4.8 | 0.53 | 0 | 0 | 0 |

Finally, as shown in Table 5, the percent difference between the feedstock chemistry and the coating chemistry for elements which oxidized during the spray process are shown in Table 5. As shown, aluminum, manganese, niobium, and silicon can oxidize and have reduced or eliminated contribution to the coating microstructure and performance accordingly. Understanding and predicting this oxidation is thus useful in developing next generation thermal spray coating alloys with high performance.

TABLE 5
Drop in coating alloy content from feedstock alloy content for
alloys evaluated in Example 1.

| Alloy | Al | Mn | Nb | Si |
|---|---|---|---|---|
| X3 | −12% | −31.5% | — | — |
| E1 | −16% | −50.8% | — | −7.5% |
| E2 | | −37.7% | — | −17.5% |
| E3 | −48% | — | −20% | −47% |

It was determined through careful experimentation that 8 wt. % oxygen can be added to the model when evaluating the thermodynamic properties of twin wire arc spray feedstock chemistries. For example, a potential feedstock chemistry such as X3 would be modelled via the following: [Fe_{BAL}Al_{1.8}Cr_{5.9}Mn_{8.2}Nb_{4.5}Ti_{0.34}V_{0.85}W_{5.3}]₉₂O₈. In the case of X3, the 8 wt. % oxygen model shows good correlation between the calculated coating chemistry and the experimentally measured coating chemistry. The comparison between the calculated and measured results is shown in Table 6. In particular, Mn, which can be advantageous for the stabilization of austenite and the readability performance criteria is predicted very well.

TABLE 6
Comparison between experimental and measured coating chemistry

| X3 | Al | Ti | V | Cr | Mn | Fe | Nb | W |
|---|---|---|---|---|---|---|---|---|
| Calculated | 0.01 | 0.01 | 0.57 | 2.74 | 8.73 | 77.33 | 3.93 | 5.75 |
| Measured | 1.76 | 0.34 | 0.85 | 5.92 | 8.22 | 73.17 | 4.45 | 5.29 |

### Example 2

In order to qualify the adhesion performance, the following test was executed.

Both the X3 and X4 alloy discussed above were tested. The samples were placed onto a fixed jig, and a robotic arm carrying the spray gun was made to raster across the samples such that a controlled coating thickness could be built up. In order to quantify the effect of coating angle samples were held at an angle of 90°, 60°, and 45° with the spray direction. Furthermore, the samples were sprayed at varying spray distances of 6″ and 9″. The purpose of this spray trial was to gauge the potential of these alloys to efficiently adhere to a substrate under a variety of plausible spray conditions. The substrates were 3″×3″×¼″ steel coupons and grit blasted to a minimum 2.5 mil blast profile. The samples were sprayed with the following spray parameters hereby referred to as “Spray Parameters 1”
TAFA 8830 Blue Air Cap
60 psi
32 V
250 Amps

Each alloy was sprayed to a target of 20 mils (0.020″). The adhesion results as a function of alloy and spray angle are shown in Table 7 for Alloy X3 and Table 8 for Alloy X4. Based on these results, both X3 and X4 alloys deposit >5,000 psi adhesion strength coatings in the twin wire arc spray process.

TABLE 7
Adhesion values in psi of Alloy X3 as a function of spray parameter

| Alloy X3 | 90° | 60° | 45° |
|---|---|---|---|
| 6″ | 5,800 | 5,708 | 6,596 |
| 9″ | 7,033 | 5,640 | 8,064 |

TABLE 8
Adhesion values in psi of Alloy X4 as a function of spray parameter

| Alloy X3 | 90° | 60° | 45° |
|---|---|---|---|
| 6″ | 6,988 | 6,064 | 6,232 |
| 9″ | 5,852 | 5,624 | 7,038 |

### Example 3

In order to qualify the X3 and X4 for utility as a twin wire arc spray product, the deposition efficiency was measured. Deposition efficiency is the measure of how much material attaches to the substrate by weight divided by how much material is sprayed by weight. A sufficiently high deposition efficiency, typically >60% (or >about 60%), is advantageous for use. In this experiment, Alloy X3 and X4 were sprayed onto a 12″×12″ rotating steel plate. The gun was held fixed in such a manner that the entire spray pattern would intersect the steel plate. The weight of wire used and the weight of coating accumulating on the plate were measured for each material to determine deposition efficiency. X3 had a measured deposit efficiency of 64% and 67% in two measurements. X4 had a deposition efficiency measurement of 70%, 71%, and 76% in three measurements.

### Example 4

In order to qualify the utility of the disclosed alloys in certain applications where abrasion performance is necessary, several wear tests were performed on the coating. For a comparative measure the non-readable and known wear resistant Fe-based coating, E2, was tested as well. The results are shown in Table 9. As shown, the X3 alloy was within the 15% scatter of the standard wear resistant material. This level of scatter is typical to the scatter of the test itself, and one would expect both coating to perform similarly in the field. Thus, it can be said that the X3 alloy possess similar wear resistance as the E2 alloy, however it is also readable.

TABLE 9
Wear testing results

| | | ASTM G65 | Hot Erosion Loss |
|---|---|---|---|
| Alloy | Vickers Hardness | (mg lost) | (mg lost) |
| X3 | 460 | 0.45 | 172.6, 178.3 |
| X4 | 400 | 0.59 | |
| E2 | Not measured | 0.38 | 164, 168.6 |

### Example 5

In order to measure the readability of each alloy careful experimentation was performed. Thermal spray coating specimens were produced such that ½ of a steel panel was sprayed and the other half of the panel was left un-sprayed. This type of sample allowed for simple comparison between a 0-1 micrometer measurement technique and an Elcometer. In this experiment, the 0-1 micrometer measurement is the accurate reading, an Elcometer reading is taken for comparison purposes to determine it the coating is readable. It is part of standard practice to calibrate the Elcometer using the intended coating to be read, and that was executed with a nominal 15 mil coating. 5 coatings of varied thicknesses were then measured using both the micrometer and the calibrated Elcometer. All samples were sprayed using “Spray Parameters 1” with a 6″ spray distance and 90° spray angle. The results of the readability measurements are shown in Table 10, which demonstrates to one skilled in the art that the X3 alloys is indeed readable. Readability is indicated by a relatively low scatter, or inaccuracy of below 20%, in the Elcometer measurements.

TABLE 10
Readability Measurements of Alloy X3

| 0-1 Micrometer | | Elcometer Standard | % |
|---|---|---|---|
| Reading | Elcometer Reading | Deviation | Inaccuracy |
| 6 | 6 | ±1 mil | 17% |
| 11-12 | 11-12 | ±1.6 mil | 13% |
| 17-18 | 17-18 | ±1.8 mil | 10% |
| 22-24 | 22-24 | ±2.5 mil | 11% |
| 34-36 | 34-36 | ±4.1 mil | 12% |

### Method for Designing Thermal Spray

In some embodiments, the alloy may be formed by blending various feedstock materials together, which may then be melted in a hearth or furnace and formed into ingots. The ingots can be re-melted and flipped one or more times, which may increase homogeneity of the ingots.

Each ingot produced was evaluated examining its microstructure, hardness and magnetic permeability. The ingots were designed to be non-magnetic and have a magnetic permeability of less than 1.01. Incremental changes in composition were made in each successive ingot, leading to the final alloys.

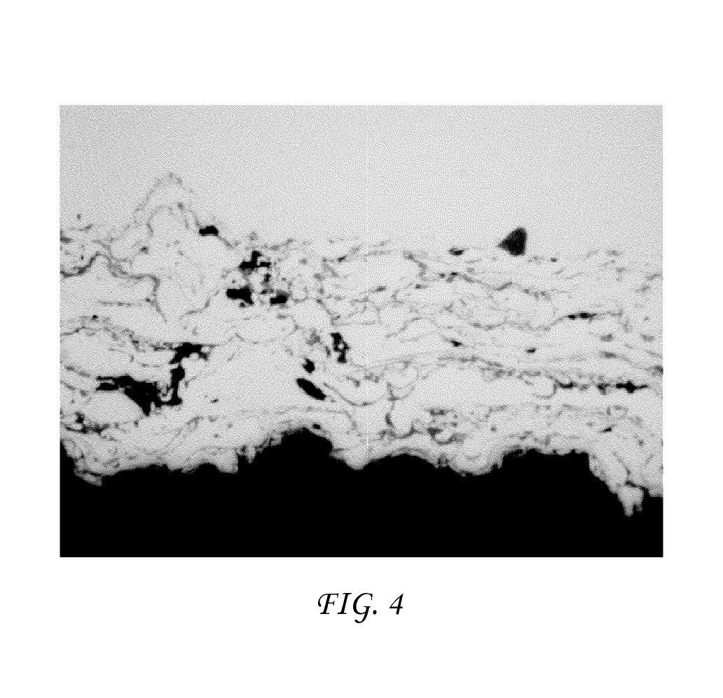

Each alloy was sectioned using a wet abrasive saw and its cross section was analyzed using optical microscopy. The ideal microstructure has few oxides or pores between the splats leaving only a dense coating of the sprayed material. Large amounts of porosity can weaken the coating adhesion and also can provide paths for corrosive media to penetrate through the coating and attack the substrate. The microstructure of one embodiment of the present disclosure is shown in FIG. 4.

The addition of Al and Ni in the alloys provides an increase to the “sprayability” of the material.

Measuring the magnetic permeability was accomplished using a Low-Mu Permeability Tester supplied from Severn Engineering. A reference standard with a known magnetic permeability is placed in the tester. The tester is comprised of the reference standard and a pivoting magnet. The magnet extends from the side of the tester opposite the reference standard. The magnet tip is brought into contact with the surface of the ingot. If the magnet is not attracted to the ingot, then the magnetic permeability is less than that of the reference standard being used.

The spraying process begins by grit blasting the steel substrate to clean off any oils or dirt while also providing a uniform surface to apply to coating onto. The coating is deposited by spraying a coating 20 mils and 60 mils thick at the following spray conditions: 32 volts, 200 amps, 5-7″ spray distance, 2-3.5 mils/pass, 85 psi atomizing pressure.

The coating adhesion is tested by bonding a 10 mm test dolly to the substrate using epoxy. The dolly is pulled in tension using a Positest AT-A adhesion tester. A minimum of 3 tests are run on each coating and the results are compiled into an average. Also of interest is the mode of coating failure and whether it is adhesive (the coating pulls completely off the substrate), adhesive (the coating itself fails without pulling off the substrate) or mixed mode experiencing both adhesive and cohesive failure.

### Properties

A plate coated with an alloy from the present disclosure having a thickness of 20 mils had an average coating adhesion value exceeding 10,000 psi. In one alloy embodiment, the thickness as measured by a magnetic thickness gage had a precision of ±0.001″ and in a second embodiment, the thickness precision ±0.00075 demonstrating good readability with sufficiently low magnetic interference.

The magnetic permeability of one alloy embodiment in ingot form was measured to be <1.01.

A plate coated with the present disclosure at a thickness of 60 mils had abrasive wear loss according to ASTM G65 Procedure B in one embodiment of 1.19 g and in another embodiment 1.13 g.

### Applications and Processes for Use:

Embodiments of the alloys described in this patent can be used in a variety of applications and industries. Some non-limiting examples of applications of use include:

Surface Mining applications include the following components and coatings for the following components: Wear resistant sleeves and/or wear resistant hardfacing for slurry pipelines, mud pump components including pump housing or impeller or hardfacing for mud pump components, ore feed chute components including chute blocks or hardfacing of chute blocks, separation screens including but not limited to rotary breaker screens, banana screens, and shaker screens, liners for autogenous grinding mills and semi-autogenous grinding mills, ground engaging tools and hardfacing for ground engaging tools, drill bits and drill bit inserts, wear plate for buckets and dumptruck liners, heel blocks and hardfacing for heel blocks on mining shovels, grader blades and hardfacing for grader blades, stacker reclaimers, sizer crushers, general wear packages for mining components and other comminution components.

Upstream oil and gas applications include the following components and coatings for the following components: Downhole casing and downhole casing, drill pipe and coatings for drill pipe including hardbanding, mud management components, mud motors, fracking pump sleeves, fracking impellers, fracking blender pumps, stop collars, drill bits and drill bit components, directional drilling equipment and coatings for directional drilling equipment including stabilizers and centralizers, blow out preventers and coatings for blow out preventers and blow out preventer components including the shear rams, oil country tubular goods and coatings for oil country tubular goods.

Downstream oil and gas applications include the following components and coatings for the following components: Process vessels and coating for process vessels including steam generation equipment, amine vessels, distillation towers, cyclones, catalytic crackers, general refinery piping, corrosion under insulation protection, sulfur recovery units, convection hoods, sour stripper lines, scrubbers, hydrocarbon drums, and other refinery equipment and vessels.

Pulp and paper applications include the following components and coatings for the following components: Rolls used in paper machines including yankee dryers and other dryers, calendar rolls, machine rolls, press rolls, digesters, pulp mixers, pulpers, pumps, boilers, shredders, tissue machines, roll and bale handling machines, doctor blades, evaporators, pulp mills, head boxes, wire parts, press parts, M.G. cylinders, pope reels, winders, vacuum pumps, deflakers, and other pulp and paper equipment,

Power generation applications include the following components and coatings for the following components: boiler tubes, precipitators, fireboxes, turbines, generators, cooling towers, condensers, chutes and troughs, augers, bag houses, ducts, ID fans, coal piping, and other power generation components.

Agriculture applications include the following components and coatings for the following components: chutes, base cutter blades, troughs, primary fan blades, secondary fan blades, augers and other agricultural applications.

Construction applications include the following components and coatings for the following components: cement chutes, cement piping, bag houses, mixing equipment and other construction applications

Machine element applications include the following components and coatings for the following components: Shaft journals, paper rolls, gear boxes, drive rollers, impellers, general reclamation and dimensional restoration applications and other machine element applications

Steel applications include the following components and coatings for the following components: cold rolling mills, hot rolling mills, wire rod mills, galvanizing lines, continue pickling lines, continuous casting rolls and other steel mill rolls, and other steel applications.

The alloys described in this patent can be produced and or deposited in a variety of techniques effectively. Some non-limiting examples of processes include:

Thermal spray process including those using a wire feedstock such as twin wire arc, spray, high velocity arc spray, combustion spray and those using a powder feedstock such as high velocity oxygen fuel, high velocity air spray, plasma spray, detonation gun spray, and cold spray. Wire feedstock can be in the form of a metal core wire, solid wire, or flux core wire. Powder feedstock can be either a single homogenous alloy or a combination of multiple alloy powder which result in the desired chemistry when melted together.

Welding processes including those using a wire feedstock including but not limited to metal inert gas (MIG) welding, tungsten inert gas (TIG) welding, arc welding, submerged arc welding, open arc welding, bulk welding, laser cladding, and those using a powder feedstock including but not limited to laser cladding and plasma transferred arc welding. Wire feedstock can be in the form of a metal core wire, solid wire, or flux core wire. Powder feedstock can be either a single homogenous alloy or a combination of multiple alloy powder which result in the desired chemistry when melted together.

Casting processes including processes typical to producing cast iron including but not limited to sand casting, permanent mold casting, chill casting, investment casting, lost foam casting, die casting, centrifugal casting, glass casting, slip casting and process typical to producing wrought steel products including continuous casting processes.

Post processing techniques including but not limited to rolling, forging, surface treatments such as carburizing, nitriding, carbonitriding, heat treatments including but not limited to austenitizing, normalizing, annealing, stress relieving, tempering, aging, quenching, cryogenic treatments, flame hardening, induction hardening, differential hardening, case hardening, decarburization, machining, grinding, cold working, work hardening, and welding.

From the foregoing description, it will be appreciated that an inventive thermal spray product and methods of use are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. An Fe-based thermal spray coating formed from an alloy, the coating comprising:
a high abrasion resistance as characterized by ASTM G65B mass loss of 1.4 grams or less; and
a generally austenitic matrix having at least 60 wt. % Fe;
wherein the coating is non-magnetic and is readable with a magnetic thickness gauge.

2. The thermal spray coating of claim 1, wherein a composition of the coating or the alloy comprises, in wt. %:
Fe;
B+C: about 1 to about 6;
Mn+Ni: about 8 to about 16; and
Al+Si: about 0 to about 14.

3. The thermal spray coating of claim 1, wherein a composition of the coating or the alloy comprises, in wt %:
Fe;
Mn: about 10 to about 18;
Cr: about 3 to about 6;
Nb: about 3 to about 6;
V: about 0 to about 6;
C: about 2 to about 5;
W: about 3 to about 6;
Ni: about 0 to about 3;
Al: about 0 to about 3; and
Ti: about 0 to about 0.5.

4. The thermal spray coating of claim 1, wherein the coating has a wear loss of 0.6 g as measured according to ASTM G65 procedure B.

5. The thermal spray coating of claim 1, wherein the coating has an adhesion strength of 5,000 psi or higher.

6. The thermal spray coating of claim 1, wherein the coating exhibits less than 200 mg loss in hot erosion testing at 600° C. and a 30° impingement angle.

7. The thermal spray coating of claim 1, wherein a thickness of the coating can be read by the magnetic thickness gauge within 20% of a 0-1 micrometer measurement.

8. The thermal spray coating of claim 1, wherein a thickness of the coating can be measured within 25% standard deviation in measurement by a magnetic thickness gauge.

9. The thermal spray coating of claim 1, wherein the alloy is a powder.

10. A component in power generation equipment at least partially coated by the thermal spray coating of claim 1.

11. A thermal spray coating formed from an alloy, the coating comprising:
an iron based matrix;
at least 5 wt. % elemental solute within the matrix; and
a high abrasion resistance as characterized by ASTM G65B mass loss of 1.4 grams or less;
wherein the coating is non-magnetic and is readable with a magnetic thickness gauge; and
wherein the alloy has a thermodynamic stable transition from austenite to ferrite at 950 K or below.

12. The thermal spray coating of claim 11, wherein a composition of the coating or the alloy comprises, in wt. %:
Fe;
B+C: about 1 to about 6;
Mn+Ni: about 8 to about 16; and
Al+Si: about 0 to about 14.

13. The thermal spray coating of claim 11, wherein a composition of the coating or the alloy comprises, in wt. %:
Fe;
Mn: about 10 to about 18;
Cr: about 3 to about 6;
Nb: about 3 to about 6;
V: about 0 to about 6;
C: about 2 to about 5;
W: about 3 to about 6;
Ni: about 0 to about 3;
Al: about 0 to about 3; and
Ti: about 0 to about 0.5.

14. The thermal spray coating of claim 11, wherein the matrix comprises at least 10 wt. % elemental solute.

15. The thermal spray coating of claim 11, wherein the matrix comprises at least 15 wt. % elemental solute.

16. The thermal spray coating of claim 11, wherein the alloy exhibits a thermodynamic stable transition from austenite to ferrite at 900 K or below.

17. The thermal spray coating of claim 11, wherein the matrix has over 90% austenite by volume and at least one non-magnetic oxide inclusion.

18. The thermal spray coating of claim 11, wherein the coating has a microhardness of 400 Vickers or higher.

19. A component in power generation equipment at least partially coated by the thermal spray coating of claim 11.

20. A method for thermally applying a coating to a substrate, the method comprising:
thermally spraying an iron-based powder alloy onto the substrate to form a coating;
wherein the coating is non-magnetic and is readable with a magnetic-thickness gauge;
wherein the coating has a microhardness of 400 Vickers or higher; and
wherein the coating has high abrasion resistance as characterized by ASTM G65B mass loss of 1.4 grams or less.
